(19) United States
(12) Patent Application Publication
(10) Pub. No.: US 2016/0054573 A1
(43) Pub. Date: Feb. 25, 2016

(54) IMAGE DISPLAY APPARATUS

(71) Applicant: Panasonic Intellectual Property Management Co., Ltd., Osaka (JP)

(72) Inventors: Masahiro KASANO, Osaka (JP); Yosuke ASAI, Osaka (JP)

(21) Appl. No.: 14/930,934

(22) Filed: Nov. 3, 2015

Related U.S. Application Data
(63) Continuation of application No. PCT/JP2014/002393, filed on May 1, 2014.

(30) Foreign Application Priority Data
Jun. 5, 2013 (JP) 2013-118545

(51) Int. Cl. G02B 27/22; G02F 1/29; G02F 1/1343

(52) U.S. Cl. CPC G02B 27/2214; G02F 1/134309; G02F 1/29

(57) ABSTRACT

An image display apparatus includes a display panel, and a liquid crystal lens disposed in front of the display panel. The liquid crystal lens includes: a first substrate and a second substrate; a first electrode layer; a second electrode layer having a plurality of electrodes formed in a stripe pattern; and a liquid crystal layer in which the direction of orientation of liquid crystal molecules is changed in accordance with an applied voltage. In the second electrode layer, the plurality of electrodes extend in a direction inclined with respect to black lines extending in a predetermined direction in a black matrix. The direction of initial orientation of the liquid crystal molecules is substantially parallel to a transmission axis of a front-surface-side polarizing plate.

### CROSS-REFERENCE TO RELATED APPLICATION

This application is a Continuation of International Application No. PCT/JP2014/002393, filed on May 1, 2014, which claims priority to Japanese Application No. 2013-118545, filed on Jun. 5, 2013, the disclosures of which applications are incorporated by reference herein.

### BACKGROUND

1. Field

The present disclosure relates to an image display apparatus including a liquid crystal lens, and the liquid crystal lens.

2. Description of the Related Art

Japanese Laid-Open Patent Publication No. 2007-226231 discloses a stereoscopic image display apparatus including a liquid crystal lens layer. The liquid crystal lens layer is a liquid crystal element having a lens effect.

### SUMMARY

The present disclosure provides an image display apparatus having high image visibility in naked eye 3D.

A disclosed image display apparatus includes a display panel, and a liquid crystal lens disposed in front of the display panel. The display panel includes: a black matrix forming a plurality of pixels and including black lines extending in a predetermined direction; and a front-surface-side polarizing plate located on a front surface side of the display panel. The liquid crystal lens includes: a first substrate and a second substrate arranged so as to oppose each other; a first electrode layer formed on the first substrate; a second electrode layer having a plurality of electrodes formed in a stripe pattern on the second substrate; and a liquid crystal layer disposed between the first electrode layer and the second electrode layer, and having a plurality of liquid crystal molecules. In the liquid crystal layer, the direction of orientation of the liquid crystal molecules is changed in accordance with a voltage applied between the first electrode layer and the second electrode layer, whereby a lens effect is generated. In the second electrode layer, the plurality of electrodes extend in a direction inclined with respect to the black lines of the black matrix. The direction of initial orientation of the liquid crystal molecules is substantially parallel to a transmission axis of the front-surface-side polarizing plate.

According to the present disclosure, an image display apparatus having high image visibility in naked eye 3D can be provided.

### BRIEF DESCRIPTION OF THE DRAWINGS

FIG. 1 is a schematic view showing the appearance of an image display apparatus 10;

FIG. 2 is a schematic cross-sectional view of the image display apparatus 10;

FIG. 3 is a partially enlarged view of the image display apparatus 10;

FIG. 4 is an exploded perspective view of a liquid crystal lens 40;

FIG. 5 is a partially enlarged view of the image display apparatus 10;

FIG. 6 is a schematic view of a liquid crystal lens 40 according to Embodiment 1, wherein (a) is a top view of the liquid crystal lens 40, and (b) is an exploded perspective view of the liquid crystal lens 40;

FIG. 7 is a schematic view of another liquid crystal lens 40 according to Embodiment 1, wherein (a) is a top view of the liquid crystal lens 40, and (b) is an exploded perspective view of the liquid crystal lens 40;

FIG. 8 is a schematic view for explaining an operation of the liquid crystal lens 40, wherein (a) is a schematic view of the liquid crystal lens 40 when 2D display is performed, and (b) is a schematic view of the liquid crystal lens 40 when 3D display is performed;

FIG. 9 is a schematic view showing the appearance of an image display apparatus 100, wherein (a) is a schematic view showing the state of horizontal display of the image display apparatus 100, and (b) is a schematic view showing the state of vertical display of the image display apparatus 100;

FIG. 10 is an exploded perspective view of a liquid crystal lens 400;

FIG. 11 is a schematic view of the liquid crystal lens 400, wherein (a) is a top view of the liquid crystal lens 400, and (b) is an exploded perspective view of the liquid crystal lens 400, and (c) is an exploded perspective view of the liquid crystal lens 400;

FIG. 12 is a schematic view showing the positional relationship between electrodes and sub pixels;

FIG. 13 is a schematic view for explaining color breakup, wherein (a) is a schematic view showing the positional relationship between electrodes and sub pixels when color breakup occurs, and (b) is a cross-sectional view taken along a line A-A′ and viewed in a Y direction;

FIG. 14 is a schematic view for explaining color breakup, wherein (a) is a schematic view showing the positional relationship between electrodes and sub pixels when horizontal display is performed, (b) is a cross-sectional view taken along a line A-A′ and viewed in a Y′ direction, (c) is a cross-sectional view taken along a line B-B′ and viewed in the Y′ direction, and (d) is a cross-sectional view taken along a line C-C′ and viewed in the Y′ direction;

FIG. 15 is a schematic view for explaining color breakup, wherein (a) is a schematic view showing the positional relationship between electrodes and sub pixels when vertical display is performed, (b) is a cross-sectional view taken along a line A-A′ and viewed in an X direction, (c) is a cross-sectional view taken along a line B-B′ and viewed in the X direction, and (d) is a cross-sectional view taken along a line C-C′ and viewed in the X direction;

FIG. 16 is an exploded perspective view of a liquid crystal lens 500;

FIG. 17 is a schematic view of the liquid crystal lens 500, wherein (a) is a top view of the liquid crystal lens 500, (b) is an exploded perspective view of the liquid crystal lens 500, and (c) is an exploded perspective view of the liquid crystal lens 500;

FIG. 18 is a schematic view showing the positional relationship between electrodes and sub pixels;

FIG. 19 is a schematic view of a liquid crystal lens 800, wherein (a) is a top view of the liquid crystal lens 800, (b) is an exploded perspective view of the liquid crystal lens 800, and (c) is an exploded perspective view of the liquid crystal lens 800;

FIG. 20 is a schematic view for explaining parameters of Examples;

FIG. 21 is a schematic view for explaining parameters of Examples;

FIG. 22 is a diagram showing Example 1, wherein (a) is a schematic view showing refractive index distribution of Example 1, (b) is a graph showing an average refractive index of Example 1, (c) is a graph showing light distribution characteristics of Example 1, and (d) is a schematic view for explaining an angle φ; and

FIG. 23 is a diagram showing Example 2, wherein (a) is a schematic view showing refractive index distribution of Example 2, (b) is a graph showing average refractive indexes of Example 2, and (c) is a graph showing light distribution characteristics of Example 2.

### DETAILED DESCRIPTION

Hereinafter, an embodiment will be described in detail with appropriate reference to the drawings. It is noted that a more detailed description than need may be omitted. For example, the detailed description of already well-known matters and the overlap description of substantially same configurations may be omitted. This is to avoid an unnecessarily redundant description below and to facilitate understanding of a person skilled in the art.

It is noted that the inventors provide the accompanying drawings and the following description in order that a person skilled in the art may fully understand the present disclosure, and do not intend to limit the subject matter defined by the claims.

### Embodiment 1

### 1. Configuration

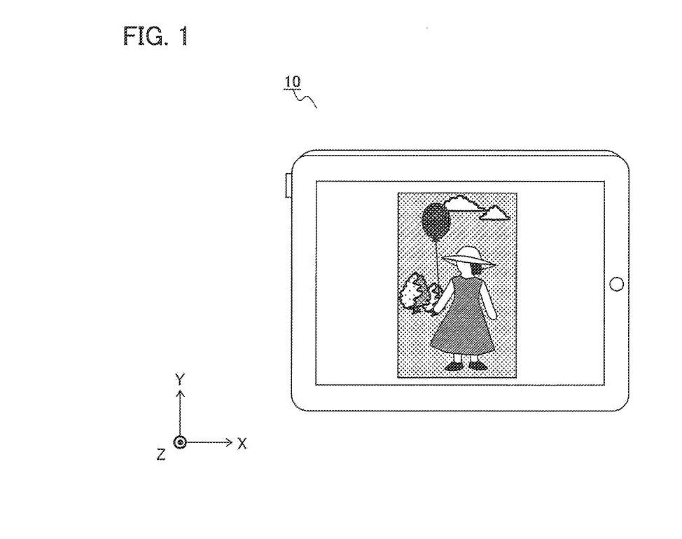

FIG. 1 is a schematic view showing the appearance of an image display apparatus 10 according to the present embodiment. As shown in FIG. 1, the image display apparatus 10 includes a screen having a substantially rectangular shape, and can be used in a horizontal display mode (in which the screen is horizontally long). In addition, the image display apparatus 10 enables switching between 3D display and 2D display by ON/OFF of a control section.

[1-1. Image Display Apparatus]

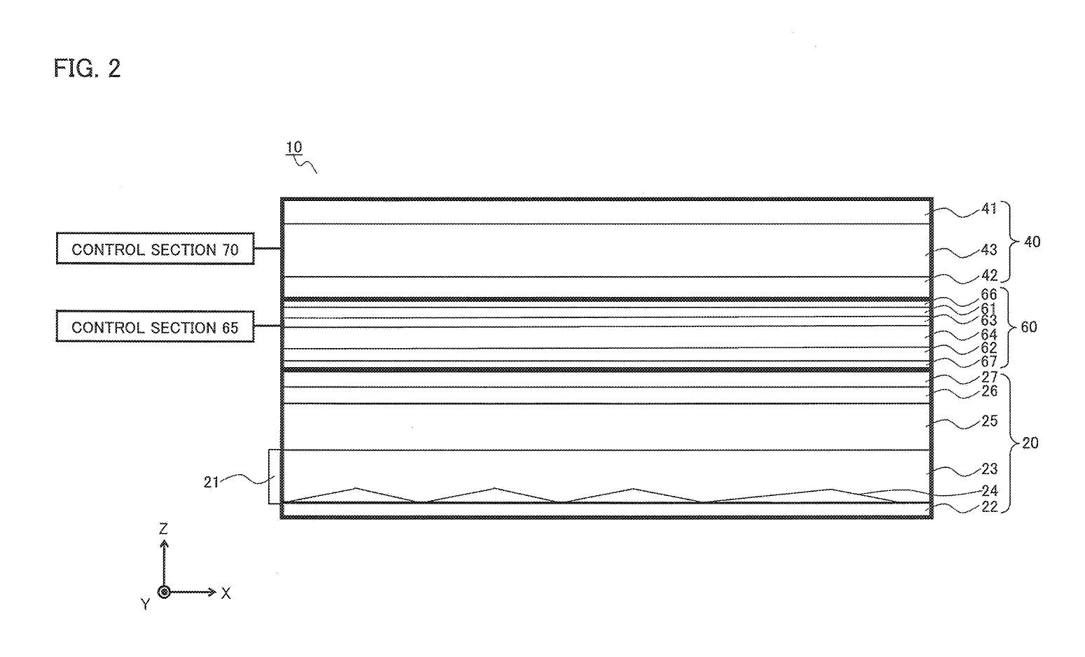

FIG. 2 is a schematic cross-sectional view of the image display apparatus 10 according to the present embodiment. In the present embodiment, a three-dimensional orthogonal coordinate system is set for the image display apparatus 10, and a direction is specified by using the coordinate axes. As shown in FIGS. 2 to 4, an X axis direction coincides with a right-left direction (horizontal direction) when a viewer faces a display surface of an image display panel 60. A Y axis direction coincides with an up-down direction when the viewer faces the display surface of the image display panel 60. A Z axis direction coincides with a direction perpendicular to the display surface of the image display panel 60. Here, “facing” means that the viewer is present directly in front of the display surface such that, for example, when a letter of “A” is displayed on the display surface, the viewer sees the letter of “A” from a correct direction. In addition, FIGS. 2 to 4 correspond to views as seen from above the image display apparatus 10. Thus, the left side in FIG. 2 corresponds to the right side of the display screen viewed from the viewer side.

As shown in FIG. 2, the image display apparatus 10 includes a backlight 20, an image display panel 60 (display panel) that is able to display a 2D image or a 3D image, a liquid crystal lens 40, a display control section 65 that controls the image display panel 60, and a control section 70 that controls the liquid crystal lens 40. The liquid crystal lens 40 is an example of an image conversion element. Hereinafter, each component will be described in detail.

The backlight 20 includes a light source 21, a reflection film 22, a light guide plate 23 having inclined surfaces 24, a diffusion sheet 25, a prism sheet 26, and a polarization reflection sheet 27. The reflection film 22 is provided at a lower surface side (back surface side) of the light guide plate 23, and the diffusion sheet 25 is provided at an upper surface side (front surface side) of the light guide plate 23.

The light source 21 is arranged along one side surface of the light guide plate 23. The light source 21 includes a plurality of LED elements arranged in the Y axis direction.

Light emitted from the light source 21 spreads in the light guide plate 23 while being repeatedly totally reflected at the upper surface and the lower surface of the light guide plate 23. Light having an angle surpassing the total reflection angle within the light guide plate 23 is emitted from the upper surface of the light guide plate 23. The lower surface of the light guide plate 23 is composed of a plurality of inclined surfaces 24 as shown in FIG. 2. By these inclined surfaces 24, light propagating in the light guide plate 23 is reflected in various directions, and thus the intensity of the light emitted from the light guide plate 23 becomes uniform across the entire upper surface.

The reflection film 22 is provided on the lower surface side of the light guide plate 23. Light having an angle surpassing the total reflection angles of the inclined surfaces 24 provided in the lower surface of the light guide plate 23 is reflected by the reflection film 22, enters the light guide plate 23 again, and is eventually emitted from the upper surface. The light emitted from the upper surface of the light guide plate 23 enters the diffusion sheet 25.

The diffusion sheet 25 is a film-like member having minute projections and recesses provided on its surface. The thickness of the diffusion sheet 25 is about 0.1 to 0.3 mm. A diffusion plate having a plurality of beads therein may be used instead of the diffusion sheet 25. The diffusion plate is thicker than the diffusion sheet 25, and thus has an effect of spreading light in the plane direction therein. Meanwhile, the diffusion sheet 25 has a small effect of spreading light in the plane direction since the diffusion sheet 25 is thinner than the diffusion plate, but the diffusion sheet 25 is able to scatter light by the projections and the recesses on its surface. In addition, use of the diffusion sheet 25 also allows reduction in the thickness of the image display apparatus 10 in the Z axis direction.

The prism sheet 26 has a countless number of minute prism arrays on one surface of a transparent film. The prism sheet 26 reflects part of light and transmits the rest. The prism sheet 26 gives, to the transmitted light, relatively strong directivity in the normal direction of the flat surface of the prism sheet 26. Thus, the prism sheet 26 brightly illuminates in an effective direction with a small amount of light.

The polarization reflection sheet 27 is a member specific to a backlight for a liquid crystal panel, transmits light of a component in a polarization direction (transmitted polarized light component), which is transmitted through the liquid crystal panel, and reflects the other components. The reflected light becomes unpolarized when being reflected on another optical member or the reflection film 22 provided on the back surface of the light guide plate 23, and enters the polarization reflection sheet 27 again, and the transmitted and polarized component of the light passes through the polarization reflection sheet 27. By repeating this, the polarized components of the light emitted from the backlight 20 are uniformed as polarized components to be used effectively in the image display panel 60 and are emitted to the image display panel 60 side. An example of the image display panel 60 is a liquid crystal panel using the In-Plane-Switching mode. However, a liquid crystal panel of another mode or a display panel other than a liquid crystal panel may also be used as the image display panel 60.

Light emitted from the backlight 20 enters the image display panel 60. The light that has entered the image display panel 60 is emitted to the liquid crystal lens 40 side.

On the incident surface and the emission surface of the image display panel 60, a polarizing plate 66 and a polarizing plate 67 each for making polarization of light uniform are provided, respectively. Hereinafter, the polarizing plate 66 provided on the emission surface of the image display panel 60 is referred to as a front-surface-side polarizing plate.

The image display panel 60 is switched between 2D display and 3D display by the display control section 65. The image display panel 60 has a plurality of pixels. Each pixel is composed of sub pixels of at least three colors (RGB). When 3D display is performed, the plurality of pixels are divided into right-eye pixels and left-eye pixels and used. Each right-eye pixel is composed of sub pixels of at least three colors (RGB). Each left-eye pixel is composed of sub pixels of at least three colors (RGB). The display control section 65 controls the image display panel 60 to display a right-eye image by using the right-eye pixels, and display a left-eye image by using the left-eye pixels. The right-eye image and the left-eye image are simultaneously displayed. The liquid crystal lens 40 causes image light of the right-eye image to enter the right eye of the viewer, and causes image light of the left-eye image to enter the left eye of the viewer.

When 2D display is performed, a 2D image is displayed using all the pixels as in the conventional art. At this time, the liquid crystal lens 40 is controlled by the control section 70 so as not to exert the lens function (lens effect). Therefore, image light of the 2D image passes through the liquid crystal lens 40 as it is and reaches the eyes of the viewer.

The liquid crystal lens 40 includes a first substrates 41, a second substrate 42, and a liquid crystal layer 43 disposed therebetween. The liquid crystal lens 40 will be described later in detail.

The control section 70 changes the value of a voltage applied to the liquid crystal lens 40 depending on whether the display mode is 2D display or 3D display. When 3D display is performed, the control section 70 applies a voltage to the liquid crystal layer 43 such that the liquid crystal lens 40 has the lens effect. When 2D display is performed, the control section 70 controls the voltage such that the liquid crystal lens 40 has no lens effect. When 2D display is performed, the control section 70 may not apply a voltage to the liquid crystal lens 40, or may apply a voltage to an extent that causes no lens effect. A voltage to be applied may be appropriately determined according to the orientation of liquid crystal molecules 49 in the liquid crystal layer 43. By controlling the applied voltage in this manner, when performing 2D display, light emitted from the image display panel 60 reaches the eyes of the viewer while the direction of the light (light distribution characteristics) is kept unchanged even when the light has passed through the liquid crystal lens 40. On the other hand, when 3D display is performed, light emitted from the image display panel 60 is deflected by the liquid crystal lens 40 such that light from the right-eye pixels is converged on the right eye of the viewer and light from the left-eye pixels is converged on the left eye of the viewer.

The image display panel 60 includes a color filter 63 for separating the light from the backlight 20 into R, G, and B. The color separation function of the color filter 63 enables the viewer to view a color image.

In the liquid crystal lens 40, orientation films 46 and 47 are formed on the liquid crystal layer 43 side of the first substrate 41 and on the liquid crystal layer 43 side of the second substrate 42, respectively. The orientation films 46 and 47 are subjected to rubbing so as to orient the liquid crystal molecules 49 in a predetermined direction, in the state where no voltage is applied between a first electrode layer 44 and a second electrode layer 45, which are described later. However, the orientation films 46 and 47 may be dispensed with, as long as the orientation of the liquid crystal molecules 49 can be kept uniform. Glass may be used as a material of the first substrate 41 and the second substrate 42.

The liquid crystal lens 40 can be produced by attaching together the first substrate 41 on which the first electrode layer 44 is formed and the second substrate 42 on which the second electrode layer 45 is formed, and injecting a liquid crystal between the first substrate 41 and the second substrate 42.

[1-2. Liquid Crystal Lens]

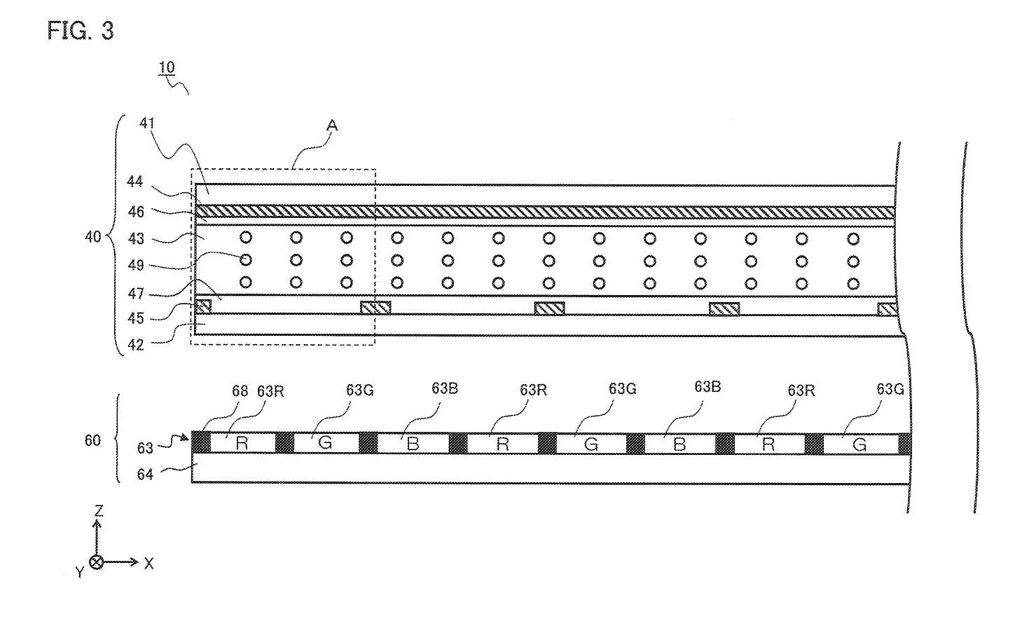

FIG. 3 is a partially enlarged view of the image display apparatus 10, showing a part of the liquid crystal lens 40 and a part of the image display panel 60.

As shown in FIG. 3, the liquid crystal lens 40 includes the first substrate 41, the second substrate 42, the liquid crystal layer 43, the first electrode layer 44, the second electrode layer 45, a first orientation film 46, and a second orientation film 47. The shape of the liquid crystal lens 40 as viewed in a planar manner is, for example, substantially rectangular like the screen of the image display apparatus 10. The long sides of the liquid crystal lens 40 extend in an X axis direction, and the short sides of the liquid crystal lens 40 extend in a Y axis direction.

The first substrate 41 and the second substrate 42 are opposing substrates arranged to be opposed each other. The first substrate 41 and the second substrate 42 are flat-plate-shaped members, and have optical transparency.

The liquid crystal layer 43 is sealed between the first substrate 41 and the second substrate 42. The liquid crystal layer 43 is composed of a plurality of liquid crystal molecules 49 having refractive index anisotropy.

The first electrode layer 44 is provided on an inner surface (surface on the liquid crystal layer 43 side) of the first substrate 41. The second electrode layer 45 is formed on an inner surface (surface on the liquid crystal layer 43 side) of the second substrate 42. The first electrode layer 44 and the second electrode layer 45 are composed of transparent electrodes having optical transparency. The second electrode layer 45 is composed of a plurality of electrodes (microelectrodes) 45a to 45e arranged in a stripe pattern on the inner surface of the second substrate 42.

The first orientation film 46 is provided between the first electrode layer 44 and the liquid crystal layer 43. The second orientation film 47 is provided between the second substrate 42 and the liquid crystal layer 43 (between the second electrode layer 45 and the liquid crystal layer 43).

The image display panel 60 includes the color filter 63 and the liquid crystal layer 64. The color filter 63 includes sub pixels 63R, 63G, and 63B partitioned by a black matrix 68.

An area A shown by a dotted line in FIG. 3 indicates an area corresponding to one lens P described later. As shown in FIG. 3, one lens P corresponds to an area including at least two sub pixels (sub pixels 63R and 63G in the case of the area A shown in FIG. 3).

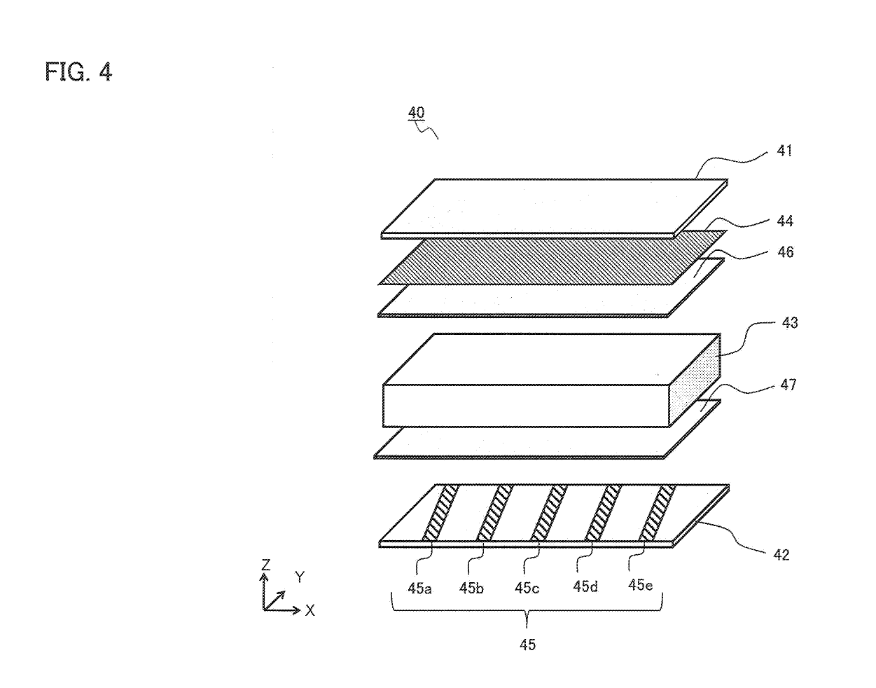

FIG. 4 is an exploded perspective view of the liquid crystal lens 40. As shown in FIG. 4, the first electrode layer 44 is composed of a single plane electrode. The second electrode layer 45 is composed of a plurality of electrodes 45a, 45b, 45c, 45d, and 45e. The single plane electrode constituting the first electrode layer 44 faces all the electrodes 45a to 45e of the second electrode layer 45. In FIG. 4, the five electrodes 45a to 45e are shown as the electrodes of the second electrode layer 45, but the number of electrodes of the second electrode layer 45 is not limited to five.

As shown in FIG. 4, the electrodes 45a to 45e constituting the second electrode layer 45 do not extend in the direction parallel to the Y axis, but extend in a direction inclined at a predetermined angle relative to the Y axis. The array configuration of the electrodes in the second electrode layer 45 will be described later in detail.

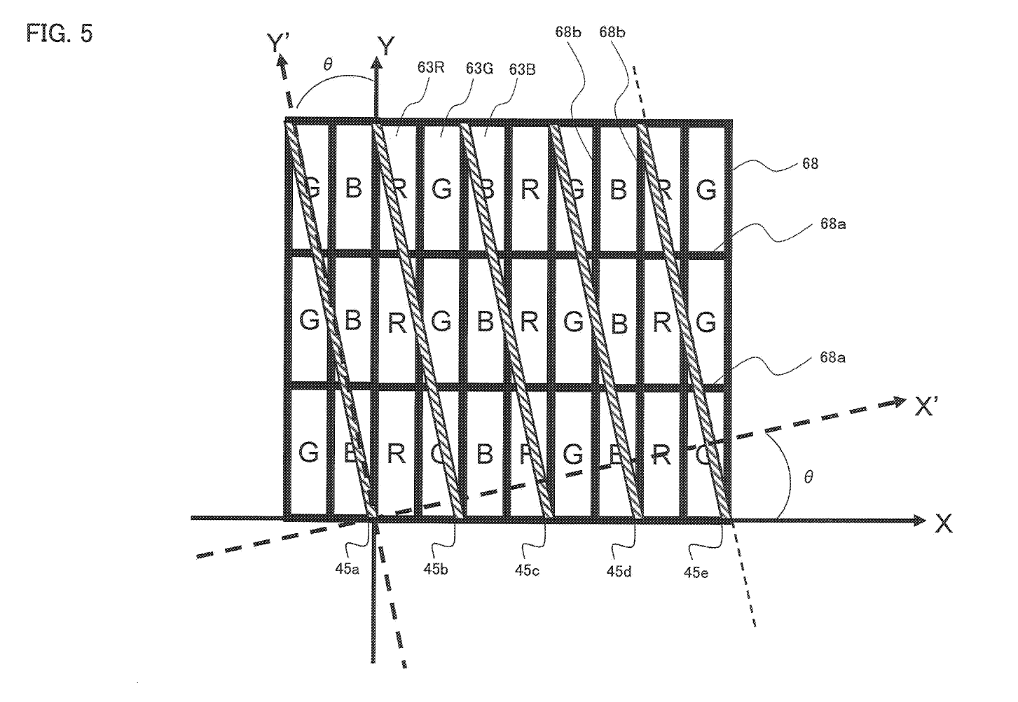

FIG. 5 is a partially enlarged view of the image display apparatus 10 according to the present embodiment. The color filter 63 has a grid-shaped black matrix 68. The black matrix 68 partitions the sub pixels 63R, 63G, and 63B by first black lines 68a extending in the X direction and second black lines 68b extending in the Y direction. In the black matrix 68, a plurality of first black lines 68a are arrayed at regular pitches in the Y axis direction, for example, and a plurality of second black lines 68b are arrayed at regular pitches in the X axis direction, for example. One pixel is composed of three sub pixels, i.e., a sub pixel 63R, a sub pixel 63G, and a sub pixel 63B. A plurality of sub pixels 63R, a plurality of sub pixels 63G, and a plurality of sub pixels 63B are arrayed in this order in the X axis direction (an example of the first direction). In addition, sub pixels of the same color are arrayed in the Y axis direction.

In addition to the XYZ coordinate axes in the three-dimensional coordinate system which have been described above, new axes are set. As shown in FIG. 5, axes obtained by rotating the X axis and the Y axis counterclockwise by an angle θ (θ≠90°) are set as an X′ axis and a Y′ axis, respectively. For example, θ is not smaller than 1° but smaller than 45°. In FIG. 5, the X′ axis and the Y′ axis are represented by dashed lines.

In the second electrode layer 45, each of the electrodes 45a to 45e is a linear electrode, and extends in a direction parallel to a Y′ axis direction (an example of the second direction). The plurality of electrodes 45a to 45e are parallel to each other, and are arranged in a stripe pattern. The electrodes 45a to 45e are arrayed at predetermined intervals in an X′ axis direction. The second electrode layer 45 is composed of the plurality of electrodes 45a to 45e extending in the Y′ axis direction. The plurality of electrodes 45a to 45e are arrayed at regular pitches in the X′ axis direction, for example.

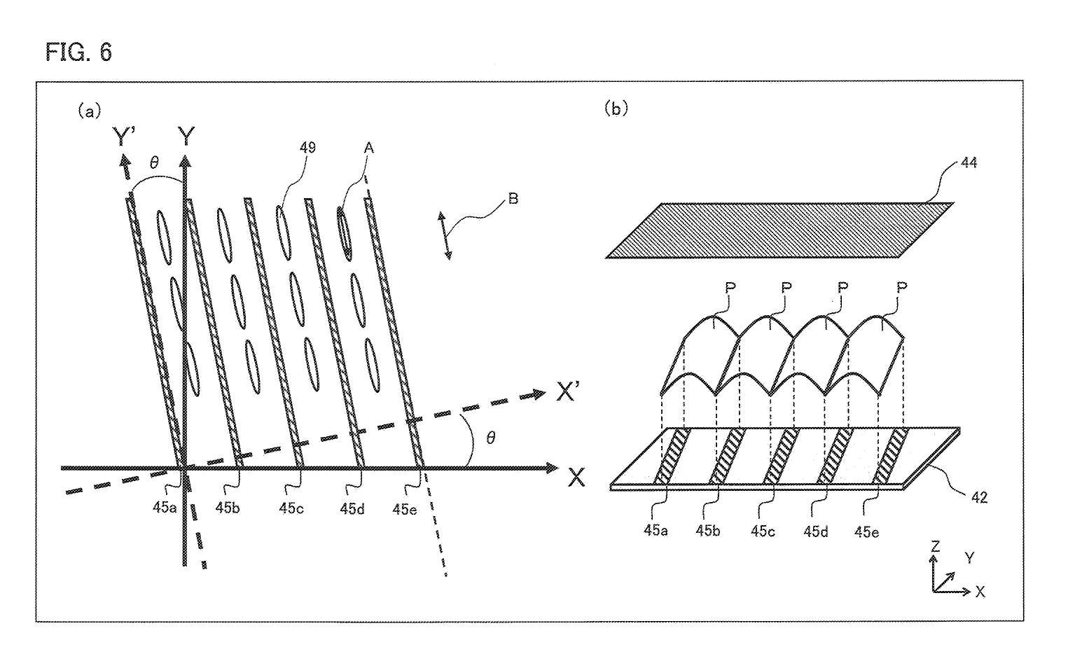

FIG. 6(a) is a top view of the liquid crystal lens 40 according to the present embodiment. FIG. 6(b) is an exploded perspective view of the liquid crystal lens 40. In FIG. 6(b), for convenience of explanation, the liquid crystal layer 43 is omitted, and virtual lenses P are shown instead of the liquid crystal layer 43.

As shown in FIG. 6(a), in the present embodiment, the direction of initial orientation of the liquid crystal molecules 49 (in FIG. 6(a), the direction of an arrow with a reference character A) is a direction parallel to the Y′ axis. The direction of initial orientation of the liquid crystal molecules 49 may be substantially parallel to the extending direction of the electrodes 45a to 45e of the second electrode layer 45, and in FIG. 6(a), is parallel to the extending direction of the electrodes 45a to 45e. In other words, in the state where no electrode is applied between the first electrode layer 44 and the second electrode layer 45 (applied voltage is 0 V), the longer axes of the liquid crystal molecules 49 are parallel to the extending direction of the electrodes 45a to 45e of the second electrode layer 45. Here, the “initial orientation” refers to an initial orientation state of the liquid crystal molecules 49 in which the liquid crystal molecules 49 are oriented due to orientation treatment performed on the first orientation film 46 and the second orientation film 47. Further, in the present embodiment, the direction of the transmission axis of the front-surface-side polarizing plate 66 (in FIG. 6(a), the direction of an arrow with a reference character B) is parallel to the Y′ axis. The direction of initial orientation of the liquid crystal molecules 49 may be substantially parallel to the transmission axis of the front-surface-side polarizing plate 66, and in FIG. 6(a), is parallel to the transmission axis of the front-surface-side polarizing plate 66. That is, the polarization direction of light (polarized light) that is emitted from the image display panel 60 and enters the liquid crystal lens 40 is parallel to the Y′ axis, and is also parallel to the direction of initial orientation of the liquid crystal molecules 49.

In the above configuration, by controlling the voltage applied between the first electrode layer 44 and the second electrode layer 45 of the liquid crystal lens 40, the same lens effect as that of the virtual lenses P (hereinafter referred to simply as lenses P) shown in FIG. 6(b) can be realized. Each lens P is a cylindrical virtual lens that is convex in the Z axis positive direction (in FIG. 6(b), the upward direction is the positive direction) with respect to the polarized light parallel to the Y′ axis, and the convex surface extends in the Y′ axis direction. One lens P appears between adjacent ones of the electrodes 45a to 45e in the second electrode layer 45. A plurality of lenses P are arrayed in the X′ axis direction. Light that has entered the lenses P from the second substrate 42 side is converged in the X′ axis direction, and emitted to the first substrate 41 side. That is, the liquid crystal lens 40 can realize optical power equivalent to that of the lens array in which the lenses P are arrayed.

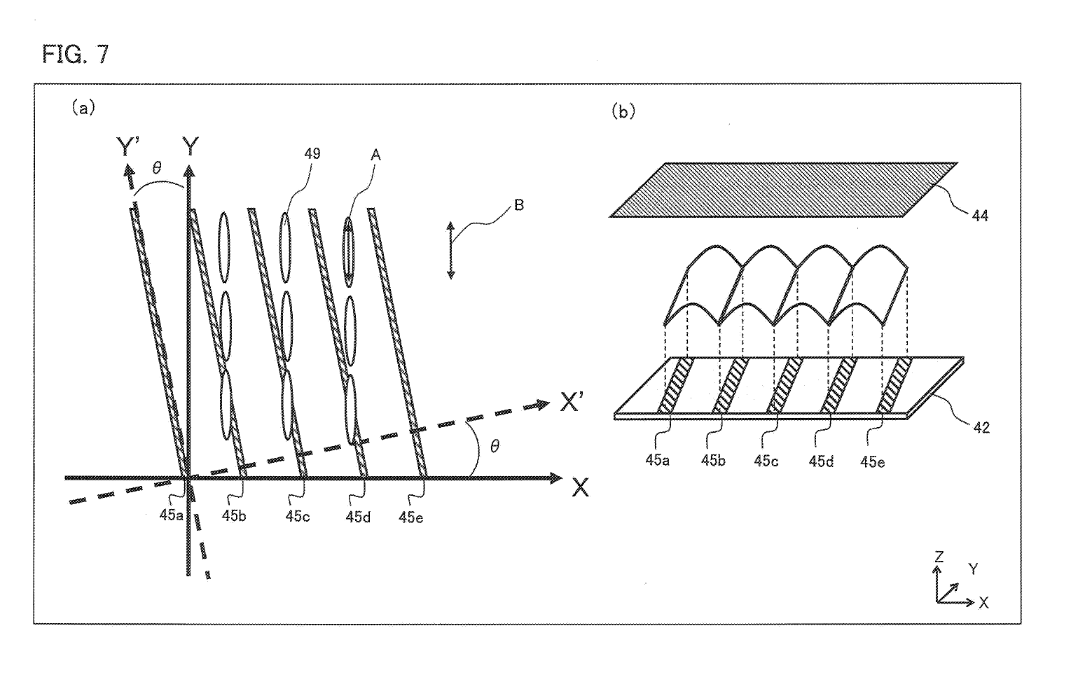

In the present embodiment, the direction of initial orientation of the liquid crystal molecules 49 is parallel to the Y′ axis. However, the direction of initial orientation of the liquid crystal molecules 49 is not limited thereto as long as it is substantially parallel to the transmission axis of the front-surface-side polarizing plate 66. For example, as shown in FIG. 7, the direction of initial orientation of the liquid crystal molecules 49 may be parallel to the Y axis. That is, the direction of initial orientation of the liquid crystal molecules 49 may be parallel to the black lines 68b that form a smaller acute angle with the electrodes 45a to 45b of the second electrode layer 45 than the black lines 68a.

FIG. 7(a) is a top view of another liquid crystal lens 40 according to the present embodiment. FIG. 7(b) is an exploded perspective view of the other liquid crystal lens 40 according to the present embodiment.

As shown in FIG. 7(a), the direction of initial orientation of the liquid crystal molecules 49 is parallel to the Y axis direction. The transmission axis of the front-surface-side polarizing plate 66 is parallel to the Y axis. That is, the polarization direction of light that is emitted from the image display panel 60 and enters the liquid crystal lens 40 is parallel to the Y axis direction. Also in this configuration, it is possible to realize the liquid crystal lens 40 as shown in FIG. 7(b) having the lens effect in the direction parallel to the X′ axis direction. The direction of the transmission axis of the front-surface-side polarizing plate 66 may be substantially parallel to the Y axis.

[1-3. Lens Effect of Liquid Crystal Lens]

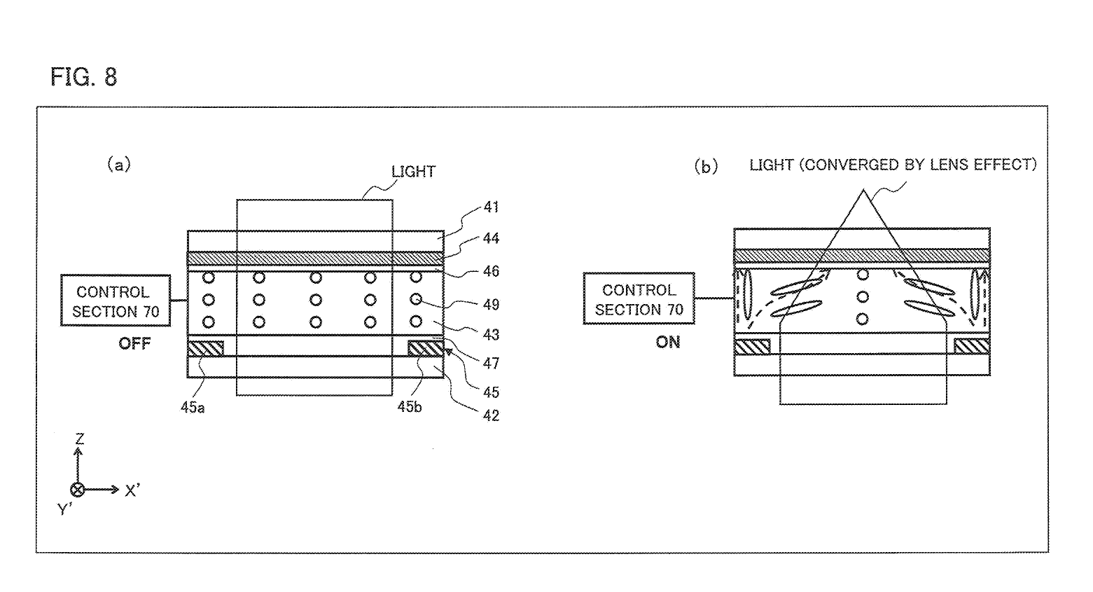

FIG. 8(a) and FIG. 8(b) are cross-sectional views of the liquid crystal lens 40 as viewed in the Y′ axis direction, and show a part of the liquid crystal lens 40 (an area corresponding to one lens P as shown in FIG. 6). FIG. 8(a) shows the liquid crystal lens 40 when 2D display is performed, and FIG. 8(b) shows the liquid crystal lens 40 when 3D display is performed.

The liquid crystal lens 40 is an element that is able to control the orientation of transmitted light in accordance with a voltage applied from the control section 70. Hereinafter, the principle will be described.

First, birefringence will be described. Birefringence is a phenomenon that an incident light ray is split into two rays depending on the state of polarization of the incident light ray. The two rays are called an ordinary ray and an extraordinary ray, respectively. A birefringence Δn is a difference between ne and no. That is, ne is a refractive index for the extraordinary ray and may be referred to as an extraordinary ray refractive index, and no is a refractive index for the ordinary ray and may be referred to as an ordinary ray refractive index.

In general, the liquid crystal molecules 49 each have an ellipsoidal shape and has different dielectric constants in the longitudinal direction and the lateral direction thereof. Thus, the liquid crystal layer 43 has a birefringence property in which a refractive index is different for each polarization direction of incident light.

In addition, when the direction of the long axis orientation (director) of each liquid crystal molecule 49 relatively changes with respect to the polarization direction of light, the refractive index of the liquid crystal layer 43 changes. Thus, when the orientation of the liquid crystal molecule is changed by an electric field generated by applying a certain voltage to the liquid crystal layer 43, the refractive index for transmitted light changes. Thus, the liquid crystal layer 43 has the lens effect when a voltage is applied with an appropriate electrode configuration.

In the present embodiment, a uniaxial positive type liquid crystal (e.g., positive type nematic liquid crystal) is used as a material for forming the liquid crystal layer 43. Thus, as shown in FIG. 8(a), the longer axes of the liquid crystal molecules are oriented in the Y′ axis direction when no voltage is applied between the opposing first electrode layer 44 and second electrode layer 45.

Since the polarization direction of light from the image display panel 60 is the Y′ axis direction, the refractive index of the liquid crystal layer 43 in the case where no voltage is applied between the first electrode layer 44 and the second electrode layer 45 is uniformly the extraordinary ray refractive index.

On the other hand, when a voltage is applied to the liquid crystal lens 40, for example, the voltage value of the electrodes 45a and 45b is set to a voltage value V1 greater than a rising voltage Vth of the liquid crystal molecules, and the voltage value of the first electrode layer 44 is set to a ground potential V0. In this case, as shown in FIG. 8(b), in a region directly above (near) the electrodes 45a and 45b, the liquid crystal molecules 49 rise, whereby the longer axes of the liquid crystal molecules 49 are oriented upward (in the Z axis direction). With decreasing distance to the center (lens center) between the electrode 45a and the electrode 45b, the longer axes of the liquid crystal molecules 49 gradually incline with respect to the X′ axis and the Z axis, and become parallel to the Y′ axis direction in the center.

The polarization direction of the light emitted from the image display panel 60 is parallel to the Y′ axis. Thus, the refractive index for the light emitted from the image display panel 60 is the ordinary ray refractive index no near the electrodes 45a and 45b, and increases with decreasing distance to the lens center. The refractive index becomes substantially the extraordinary ray refractive index ne at the lens center.

As a result, refractive index distribution occurs in the liquid crystal layer 43. Since light is deflected from a lower refractive index toward a higher refractive index, light incident on the lens in parallel to the lens is deflected toward the lens center, for example.

The control section 70 controls the liquid crystal lens 40 such that no voltage is applied between the first electrode layer 44 and the second electrode layer 45 as shown in FIG. 8(a) when a 2D image is viewed while a voltage is applied between the first electrode layer 44 and the second electrode layer 45 as shown in FIG. 8(b) when a 3D image is viewed. Thus, when the 2D image is viewed, light incident on the liquid crystal lens 40 passes therethrough as it is without being subject to a lens effect. When the 3D image is viewed, light that has passed through the liquid crystal lens 40 is converged on the eyes of the viewer.

### 2. Effects and the Like

As described above, the liquid crystal lens 40 of the present embodiment includes the first substrate 41, the second substrate 42, the first electrode layer 44, the second electrode layer 45, and the liquid crystal layer 43. The first substrate 41 and the second substrate 42 are arranged to be opposed each other. The first electrode layer 43 is formed on the first substrate 41. The second electrode layer 45 includes the plurality of electrodes 45a, 45b, . . . which are formed in a stripe pattern on the second substrate 42. In the second electrode layer 45, the plurality of electrodes 45a, 45b, . . . are arrayed in the X axis direction (an example of the first direction). The liquid crystal layer 43 is disposed between the first substrate 41 and the second substrate 42. The liquid crystal layer 43 includes the plurality of liquid crystal molecules 49 having refractive index anisotropy. The liquid crystal layer 43 has the lens effect when the direction of orientation (array direction) of the liquid crystal molecules 49 changes according to the voltage applied between the first electrode layer 44 and the electrodes of the second electrode layer 45. The plurality of electrodes 45a, 45b, . . . extend in the Y′ direction (an example of the second direction) forming a predetermined angle θ (θ≠90°) with respect to the Y axis direction. That is, in the second electrode layer 45, the plurality of electrodes 45a, 45b, . . . extend in the direction inclined with respect to the black lines 68b extending in the Y axis direction in the black matrix 68. In addition, the direction of initial orientation of the liquid crystal molecules 49 is substantially parallel to the transmission axis of the front-surface-side polarizing plate 66.

By setting the direction of initial orientation of the liquid crystal molecules 49 as described above, the direction of initial orientation of the liquid crystal molecules 49 is substantially parallel to the polarization direction of light that enters the liquid crystal lens 40. Therefore, it is possible to realize the liquid crystal lens 40 that can obtain nearly ideal refractive index distribution when 3D display is performed. Further, in the liquid crystal lens 40 shown in FIG. 6, since the direction of initial orientation of the liquid crystal molecules 49 is substantially parallel to the extending direction of the electrodes 45a, 45b, . . . of the second electrode layer 45, it is possible to realize the liquid crystal lens 40 that can obtain almost ideal refractive index distribution. As a result, crosstalk is reduced, and an image display apparatus 10 having high image visibility in naked eye 3D can be realized.

Further, by mounting, on the image display apparatus 10, the liquid crystal lens 40 in which the plurality of electrodes 45a, 45b, . . . of the second electrode layer 45 extend in the direction inclined with respect to the black lines 68b, occurrence of moire can be reduced as compared to the case where the electrodes 45a, 45b, . . . are arrayed without being inclined with respect to the black lines 68b.

The “moire” is also called “interference fringes”, and means a stripe pattern that visually occurs, when multiple repetitive regular patterns are superimposed, due to shifts in cycle among these patterns.

Occurrence of moire is explained taking, as an example, the configuration in which the electrodes 45a, 45b, . . . extend in the Y axis direction. At this time, the black matrix 68 also has the plurality of black lines 68b extending in the Y axis direction. That is, in the black matrix 68, the plurality of black lines 68b extending in the Y axis direction form a stripe pattern. In this configuration, moire occurs due to shifts in cycle between the stripe pattern of the electrodes 45a, 45b, . . . and the stripe pattern of the black lines 68b.

On the other hand, in the present embodiment, the electrodes 45a, 45b, . . . extend in the Y′ axis direction. That is, the electrodes 45a, 45b, . . . form a diagonal stripe pattern. When this diagonal stripe pattern is superimposed on the stripe pattern of the black lines 68b, the amount of moire can be reduced as compared to the case where a stripe pattern is superimposed on a stripe pattern.

Therefore, the liquid crystal lens 40 of the present embodiment can reduce occurrence of moire, as compared to the case where the electrodes 45a, 45b, . . . are arrayed without being inclined with respect to the black lines 68b.

### Embodiment 2

Hereinafter, an image display apparatus 100 according to Embodiment 2 will be described. In Embodiment 1, the first electrode layer 44 is composed of a single plane electrode. In the present embodiment, a first electrode layer 440 is composed of a plurality of electrodes (microelectrodes) 440a, 440b, . . . . Hereinafter, differences from Embodiment 1 will be mainly described. The same functions and components as those of Embodiment 1 may be given the same reference numerals to omit repeated description thereof.

[1-1. Image Display Apparatus]

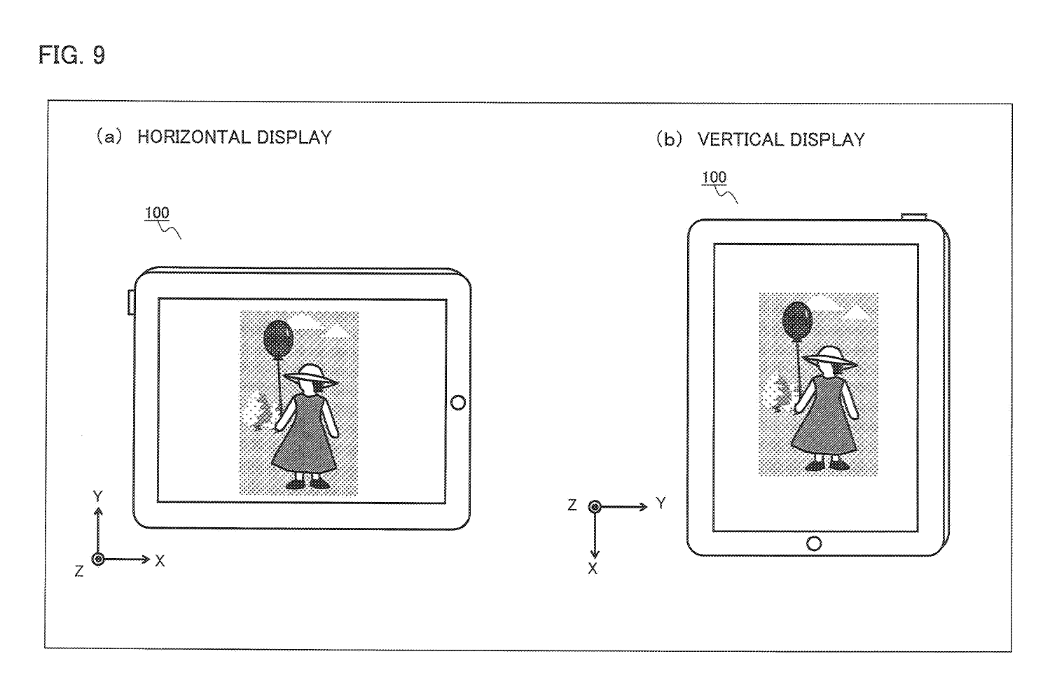

FIG. 9 is a schematic view showing the appearance of the image display apparatus 100 according to the present embodiment, which enables switching between vertical display and horizontal display. The image display apparatus 100 can be used in a horizontal display mode (in which the screen is horizontally long) shown in FIG. 9(a). By rotating the image display apparatus 100 clockwise by 90° degrees from the state shown in FIG. 9(a), the image display apparatus 100 can also be used in a vertical display mode (in which the screen is vertically long) shown in FIG. 9(b). When the image display apparatus 100 is rotated from the state shown in FIG. 9(a) to the state shown in FIG. 9(b), the display content on the image display apparatus 100 is rotated counterclockwise by 90°. This allows the viewer to view the same image in the vertical display and the horizontal display. The image display apparatus 100 enables switching between 3D display and 2D display by ON/OFF of the control section, like in Embodiment 1.

[1-2. Liquid Crystal Lens]

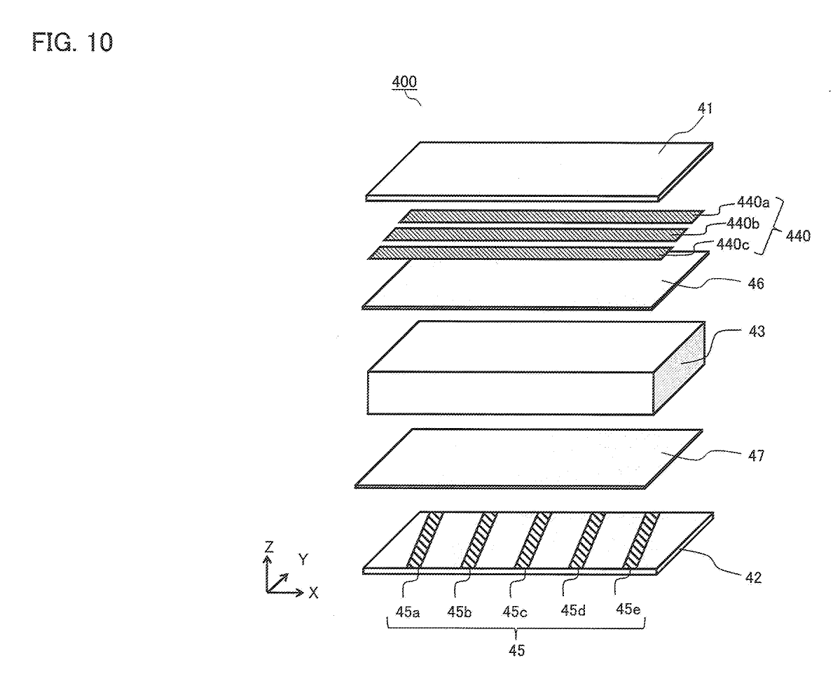

FIG. 10 is an exploded perspective view showing a liquid crystal lens 400 according to the present embodiment.

The liquid crystal lens 400 includes a first substrate 41, a second substrate 42, a liquid crystal layer 43, a first electrode layer 440, a second electrode layer 45, a first orientation film 46, and a second orientation film 47.

The first electrode layer 440 is composed of a plurality of electrodes 440a, 440b, and 440c. In FIG. 10, three electrodes 440a to 440c are shown as electrodes of the first electrode layer 440. However, the number of the electrodes of the first electrode layer 440 is not limited three. In the first electrode layer 440, each of the electrodes 440a to 440c is a linear electrode extending in the X axis direction. The electrodes 440a to 440c are parallel with each other, and are arranged in a stripe pattern. The electrodes 440a to 440c are arrayed at predetermined intervals in the Y axis direction. The intervals are set so that a left-eye pixel and a right-eye pixel are disposed between adjacent ones of the electrodes 440a to 440c.

The second electrode layer 45 is composed of a plurality of electrodes 45a to 45e, like in Embodiment 1.

By controlling a voltage applied between the first electrode layer 440 and the second electrode layer 45, the optical function of the liquid crystal lens 400 can be switched between a function suitable for vertical display and a function suitable for horizontal display.

[1-3. Liquid Crystal Lens]

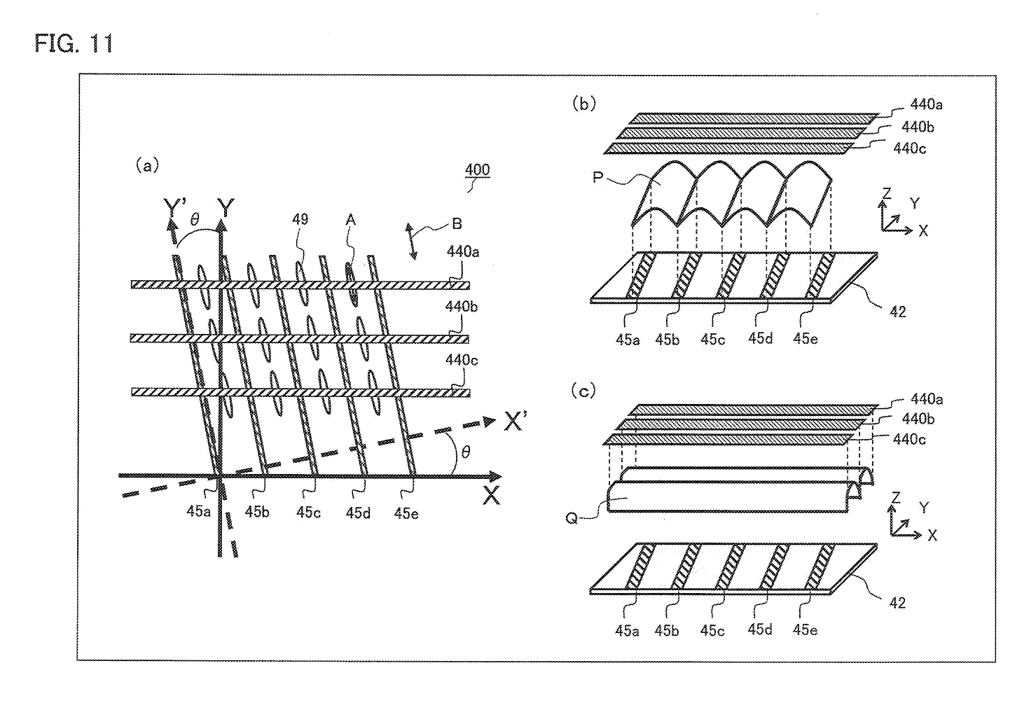

With reference to FIG. 11, the relationship between the arrangement of the electrodes 45a to 45e and the orientation of the liquid crystal molecules 49 will be described.

FIG. 11(a) is a top view of the liquid crystal lens 400. FIG. 11(b) is an exploded perspective view of the liquid crystal lens 400, and shows virtual lenses P instead of the liquid crystal layer 43. FIG. 11(c) is an exploded perspective view of the liquid crystal lens 400, and virtual lenses Q are shown instead of the liquid crystal layer 43.

As shown in FIG. 11(a), each of the electrodes 440a to 440c is an electrode extending in a direction parallel to the X axis direction. The electrodes 440a to 440c are arranged at predetermined intervals in the Y axis direction. The first electrode layer 440 is composed of the plurality of electrodes 440a to 440c arranged in a stripe pattern.

Each of the electrodes 45a to 45e is an electrode extending in a direction parallel to the Y′ axis direction. The electrodes 45a to 45e are arranged at predetermined intervals in the X′ axis direction. The second electrode layer 45 is composed of the plurality of electrodes 45a to 45e arranged in a stripe pattern.

The direction of initial orientation of the liquid crystal molecules 49 (in FIG. 11(a), the direction of an arrow with a reference character A) is a direction parallel to the Y′ axis. The direction of initial orientation of the liquid crystal molecules 49 may be substantially parallel to the extending direction of the electrodes 45a to 45e of the second electrode layer 45, and in FIG. 11(a), is parallel to the extending direction of the electrodes 45a to 45e. In the present embodiment, the direction of the transmission axis of the front-surface-side polarizing plate 66 (in FIG. 11(a), the direction of an arrow with a reference character B) is parallel to the Y′ direction. That is, the polarization direction of light that is emitted from the image display panel 60 and enters the liquid crystal lens 40 is parallel to the Y′ axis, and is also parallel to the direction of initial orientation of the liquid crystal molecules 49.

In the above-configuration, by controlling a voltage applied between the first electrode layer 440 and the second electrode layer 45 of the liquid crystal lens 400, the same lens effect as that of the virtual lenses P (hereinafter referred to simply as lenses P) shown in FIG. 11(b) or the same lens effect as that of the virtual lenses Q (hereinafter referred to simply as lenses Q) shown in FIG. 11(c) can be realized.

As shown in FIG. 11(b), each lens P is a cylindrical virtual lens that is convex in the Z axis positive direction with respect to the polarized light parallel to the Y′ axis, and the convex surface extends in the Y′ axis direction. A plurality of lenses P are arrayed in the X′ axis direction. Light that has entered the lenses P from the second substrate 42 side is converged in the X′ axis direction, and emitted to the first substrate 41 side. That is, the liquid crystal lens 400 can realize optical power equivalent to that of the lens array in which the lenses P are arrayed. The liquid crystal lens 400 shown in FIG. 11(b) can be used for horizontal display.

As shown in FIG. 11(c), each lens Q is a cylindrical virtual lens that is convex in the Z axis positive direction with respect to the polarized light parallel to the Y′ axis, and the convex surface extends in the X axis direction. A plurality of lenses Q are arrayed in the Y axis direction. Light that has entered the lenses Q from the second substrate 42 side is converged in the Y axis direction, and emitted to the first substrate 41 side. That is, the liquid crystal lens 400 can realize optical power equivalent to that of the lens array in which the lenses Q are arrayed. The liquid crystal lens 400 shown in FIG. 11(c) can be used for vertical display.

### 2. Effects and the Like

As described above, the first electrode layer 440 of the liquid crystal lens 40 according to the present embodiment includes the plurality of electrodes 440a to 440c that are formed in a stripe pattern on the first substrate 41, and intersect the plurality of electrodes 45a to 45e of the second electrode layer 45. Therefore, it is possible to realize the image display apparatus 100 capable of performing 3D display in both the horizontal display and the vertical display. The electrode configuration of the second electrode layer 45 can reduce occurrence of moire, like in Embodiment 1. Further, the electrode configuration can reduce occurrence of color breakup.

The “color breakup” is a phenomenon that the contour of an object (picture or character) displayed on the display surface is separated into three colors of R, G, B when visually recognized by the viewer. Hereinafter, the “color breakup” will be described in detail.

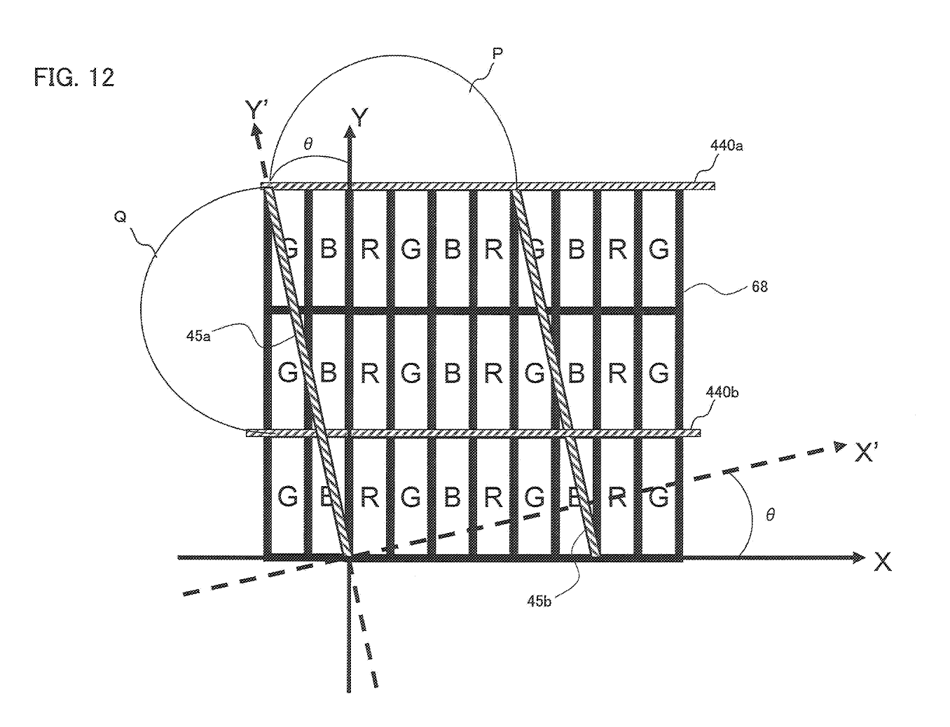

FIG. 12 is a schematic view showing the relationship between the arrangement of the electrodes 440a, 440b, 45a, and 45b and the array of the pixels. As shown in FIG. 12, sub pixels of R, G, B are arrayed in order of R, G, B, R, G, B, . . . in the X axis direction. Further, sub pixels of the same color are arrayed in the Y axis direction.

An optical function that provides the lens effect of the lenses P is realized by using the electrodes 45a and 45b (e.g., by setting the voltage value of the electrodes 45a and 45b to V1 (V1>Vth), and setting the electrodes 440a and 440b at the ground potential), and an optical function that provides the lens effect of the lenses Q is realized by using the electrodes 440a and 440b (e.g., by setting the voltage value of the electrodes 440a and 440b to V1 (V1>Vth), and setting the electrodes 45a and 45b at the ground potential). While in FIG. 12 each lens P is illustrated so as to be convex in the Y axis direction, this is merely for easy understanding. As described with reference to FIG. 11(b), actually, each lens P is convex in the Z axis positive direction. Likewise, while in FIG. 12 each lens Q is convex in the X axis negative direction, this is merely for easy understanding. As shown in FIG. 11(c), actually, the lens Q is convex in the Z axis positive direction.

As shown in FIG. 12, the electrode 440a and the electrode 440b are disposed with a space corresponding to two sub pixels between them. The electrode 45a and the electrode 45b are disposed with a space corresponding to six sub pixels (i.e., the number of sub pixels corresponding to two pixels) between them. Hereinafter, behavior of light emitted from the sub pixels will be described in detail.

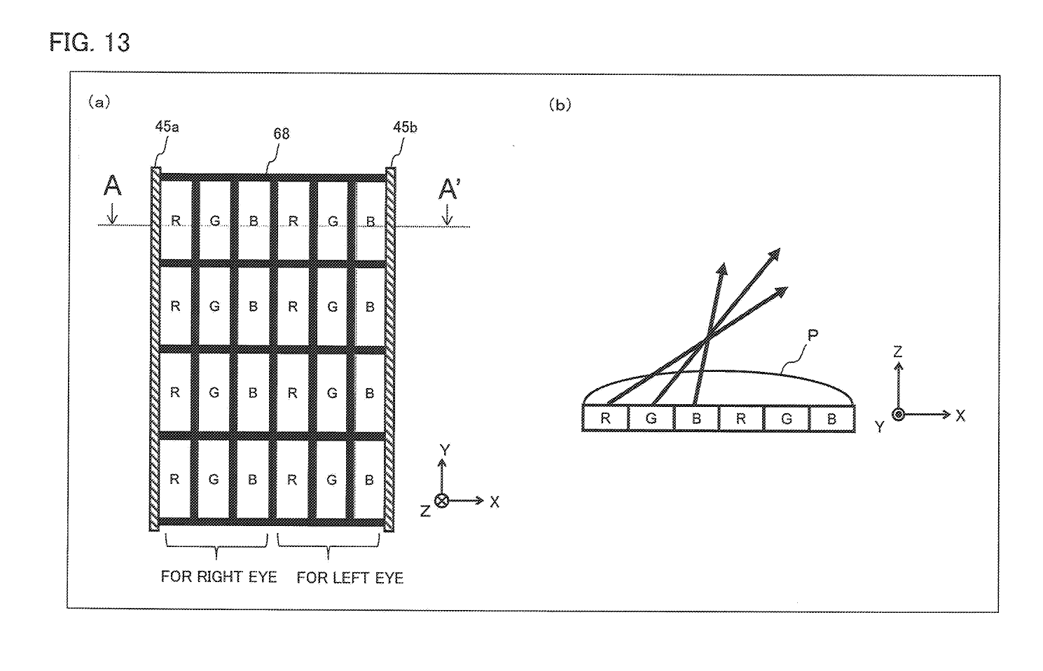

FIG. 13 is a schematic view for explaining the principle of occurrence of color breakup. FIG. 13(a) shows the arrangement of the sub pixels and the electrodes 45a and 45b in the case where the electrodes 45a and 45b extend in the Y axis direction (i.e., do not extend in the Y′ axis direction). FIG. 13(b) is a cross-sectional view taken along a line A-A′ in FIG. 13(a) and viewed in the Y axis direction, and shows the directions of main light rays of light beams emitted from the respective sub pixels for right eye. The light beams emitted from the respective sub pixels advance in the directions shown by arrows in FIG. 13(b) due to the optical function of the lens P.

As shown in FIG. 13(a), six sub pixels are arrayed between the electrode 45a and the electrode 45b. In this embodiment, the sub pixels of R, G, B arranged on the electrode 45a side are used as right-eye sub pixels, and the sub pixels of R, G, B arranged on the electrode 45b side are used as left-eye sub pixels.

As shown in FIG. 13(b), regarding the right-eye pixel, the main light rays of light beams emitted from the sub pixels of R, G, B advance in different directions. Therefore, the light beams of R, G, B are not mixed but are separated from each other when reaching the right eye of the viewer. Likewise, regarding the left-eye pixel, light beams of R, G, B are not mixed but are separated from each other when reaching the left eye of the viewer, although not shown in the figure. As a result, the contour of the object (picture or character) displayed on the display surface is separated into three colors of R, G, B when visually recognized by the viewer. In other words, color breakup occurs.

Such phenomenon occurs not only in the region of the sub pixels at the line A-A′ in FIG. 13(a) but also in any region in the Y axis direction.

However, in the present embodiment, the plurality of electrodes 45a, 45b, . . . are arranged so as to extend in the Y′ direction (an example of the second direction) forming a predetermined angle θ (θ≠90°; θ is not smaller than 1° but smaller than 45°) with respect to the Y axis direction, whereby occurrence of color breakup can be reduced.

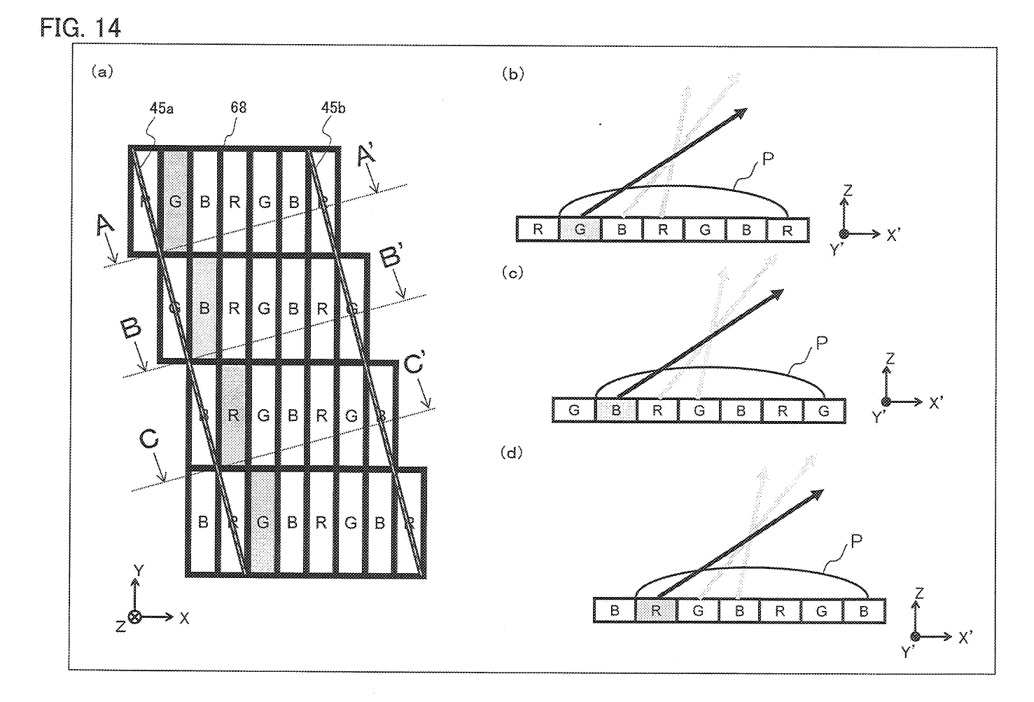

FIG. 14 shows the positional relationship between the sub pixels and the lens P according to the present embodiment. FIG. 14(a) is a schematic view showing the positional relationship between the sub pixels and the electrodes 45a and 45b. FIG. 14(b) is a cross-sectional view taken along a line A-A′ in FIG. 14(a) and viewed in the Y′ axis direction. FIG. 14(c) is a cross-sectional view taken along a line B-B′ in FIG. 14(a) and viewed in the Y′ axis direction. FIG. 14(d) is a view taken along a line C-C′ in FIG. 14(a) and viewed in the Y′ axis direction.

As shown in FIG. 14(a), the electrodes 45a and 45b are arranged to be inclined with respect to the Y axis. Therefore, as shown in FIGS. 14(b) to 14(d), the positional relationship between the sub pixels and the lens P varies depending on the position. In FIG. 14, specific pixels are filled with gray color, and the reason therefor will be described later.

As shown in FIG. 14(b), in the region shown by the line A-A′, six sub pixels of G, B, R, G, B, R are arrayed in order along the X′ axis direction, and correspond to one lens P in the liquid crystal lens 40. The directions of main light rays of light beams emitted from the respective sub pixels of G, B, R are shown by arrows.

As shown in FIG. 14(c), in the region shown by the line B-B′, six sub pixels of B, R, G, B, R, G are arrayed in order in the X′ axis direction, and correspond to one lens P in the liquid crystal lens 40. That is, the position of the lens P shown in FIG. 14(c) is by 1 sub pixel shifted in the X′ axis direction with respect to the position of the lens P shown in FIG. 14(b). The directions of main light rays of light beams emitted from the sub pixels of B, R, G are shown by arrows.

As shown in FIG. 14(d), in the region shown by the C-C′, six sub pixels of R, G, B, R, G, B are arrayed in order in the X′ axis direction, and correspond to one lens P in the liquid crystal lens 40. That is, the position of the lens P shown in FIG. 14(d) is by 1 sub pixel shifted in the X′ axis direction with respect to the position of the lens P shown in FIG. 14(c). The directions of main light rays of light beams emitted from the sub pixels of R, G, B are shown by arrows.

By using the shift of the lens P with respect to the sub pixels in the liquid crystal lens 40, the sub pixels of G, B, R filled with gray color, among the sub pixels shown in FIG. 14(a), can be regarded as one pixel. That is, not a combination of the sub pixels arrayed in the X axis direction but a combination of the sub pixels arrayed in the Y′ axis direction can be regarded as one pixel. Specifically, the sub pixel of G filled with gray color in FIG. 14(b), the sub pixel of B filled with gray color in FIG. 14(c), and the sub pixel of R filled with gray color in FIG. 14(c) have the main light rays in the same direction. That is, by using a combination of these sub pixels as one pixel, the main light rays of the RGB three colors can be aligned. For example, by using these sub pixels as a right-eye pixel, light beams of RGB three colors aligned in the same direction enter the right eye of the viewer. Therefore, the viewer can visually recognize an image of less color breakup.

Regarding the left-eye pixel, the sub pixel of B positioned second from the right in FIG. 14(b), the sub pixel of R positioned second from the right in FIG. 14(c), and the sub pixel of G positioned second from the right in FIG. 14(c) have the major light rays in the same direction. Therefore, by using these sub pixels as a left-eye pixel, light beams of RGB three colors aligned in the same direction enter the left eye of the viewer.

While the sub pixels whose main light rays extend in the upper right direction have been described, the same phenomenon as described above occurs also in other sub pixels. That is, by selecting, as a right-eye or left-eye pixel, a combination of three sub pixels of R, G, B whose main light rays are in the same direction, occurrence of color breakup can be reduced as compared to the conventional art. Among the plurality of pixels of the image display panel 60, a combination of sub pixels of multiple colors which are diagonally adjacent to each other with respect to the black lines 68b in the direction along the electrodes 45a to 45b is regarded as one pixel (right-eye pixel or left-eye pixel), whereby occurrence of color breakup can be reduced when horizontal display is performed.

Next, the case of vertical display shown in FIG. 9(b) will be described. In this case, no color breakup occurs. The reason therefor will be described later in detail.

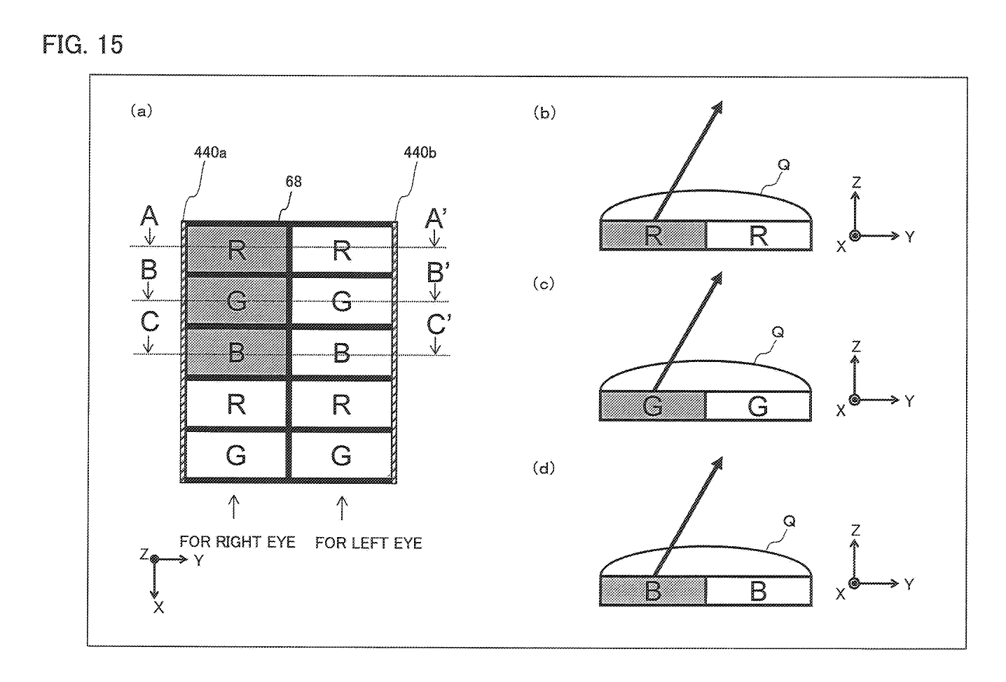

FIG. 15(a) is a schematic view showing the positional relationship between the electrodes 440a and 440b, and the respective sub pixels. FIG. 15 corresponds to FIG. 12 rotated clockwise by 90°. That is, FIG. 15 shows a state corresponding to the vertical display shown in FIG. 9(b). FIG. 15(b) is a cross-sectional view taken along a line A-A′ in FIG. 15(a) and viewed in the X axis direction. FIG. 15(c) is a cross-sectional view taken along a line B-B′ in FIG. 15(a) and viewed in the X axis direction. FIG. 15(d) is a cross-sectional view taken along a line C-C′ in FIG. 15(a) and viewed in the X axis direction.

As shown in FIG. 15(a), between the electrode 440a and the electrode 440b, two sub pixels of the same color are arrayed in the Y axis direction, and sub pixels of RGB three colors are arrayed in the X axis direction. The sub pixels arrayed on the electrode 440a side are regarded as right-eye sub pixels, and the sub pixels arrayed on the electrode 440b side are regarded as left-eye sub pixels.

Arrows shown in FIGS. 15(b) to 15(d) represent main light rays of light beams emitted from the right-eye sub pixels. As shown in FIGS. 15(b) to 15(d), the main light rays of light beams emitted from the right-eye sub pixels extend in the same direction. That is, the light beams emitted from the respective sub pixels, having the main light rays in the same direction, are converged on the right eye of the viewer. That is, the positional relationship between the electrodes 440a and 440b and the sub pixels as shown in FIG. 15(a) does not cause color breakup. Thus, among the plurality of pixels of the image display panel 60, a combination of sub pixels of multiple colors which are adjacent to each other in the direction along the electrodes 440a to 440c is regarded as one pixel (right-eye pixel or left-eye pixel), whereby occurrence of color breakup can be reduced when vertical display is performed.

As described above, in the present embodiment, the plurality of electrodes 45a, 45b, . . . are arranged so as to extend in the Y′ direction (an example of the second direction) forming a predetermined angle θ (θ≠90°) with respect to the X axis direction. This configuration can reduce occurrence of color breakup in both the vertical display and the horizontal display.

### 3. Modification

Hereinafter, an image display apparatus according to a modification of Embodiment 2 will be described. In this modification, in contrast to Embodiment 2, a plurality of electrodes 550a to 550c of a first electrode layer 550 intersect at right angles with the plurality of electrodes 45a to 45e of the second electrode layer 45. Hereinafter, differences from Embodiment 2 will be described mainly. The same functions and components as those of Embodiment 2 may be given the same reference numerals to omit repeated description thereof. The appearance of the image display apparatus according to this modification is identical to that of the image display apparatus 100 of Embodiment 2 shown in FIG. 9.

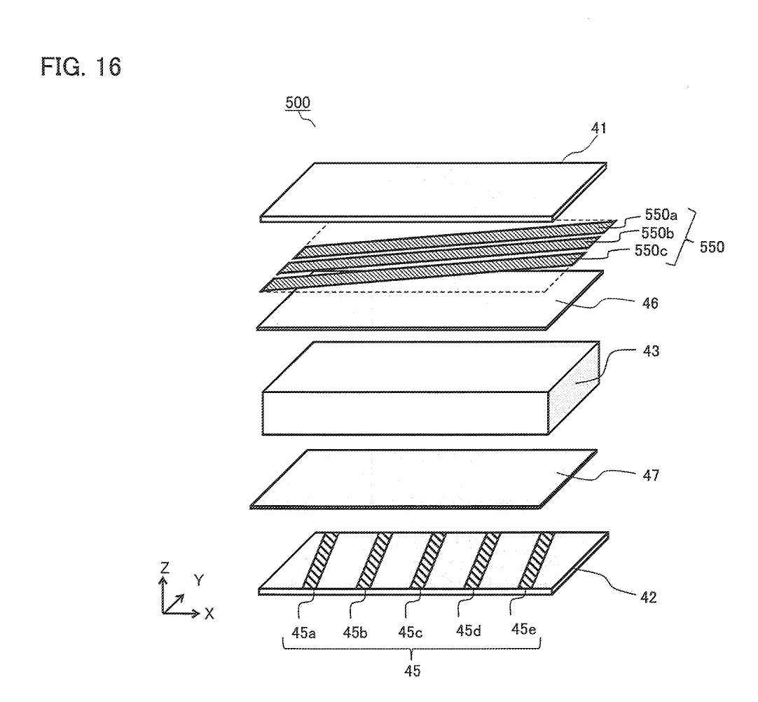

FIG. 16 is an exploded perspective view of a liquid crystal lens 500 according to the modification.

As shown in FIG. 16, the first electrode layer 550 is composed of a plurality of electrodes 550a, 550b, and 550c. The number of the electrodes of the first electrode layer 550 is not limited to that shown in FIG. 16. In the first electrode layer 550, each of the electrodes 550a to 550c is a linear electrode extending in the X′ axis direction. The electrodes 550a to 550c are parallel to each other, and are arranged in a stripe pattern. The electrodes 550a to 550c are arrayed at predetermined intervals in the Y′ axis direction. The intervals are set so that a left-eye pixel and a right-eye pixel are disposed between adjacent ones of the electrodes 440a to 440c.

On the other hand, the second electrode layer 45 is composed of a plurality of electrodes 45a to 45e like in Embodiment 1. By controlling a voltage applied between the first electrode layer 550 and the second electrode layer 45, the optical function of the liquid crystal lens 500 can be switched between a function suitable for vertical display and a function suitable for horizontal display.

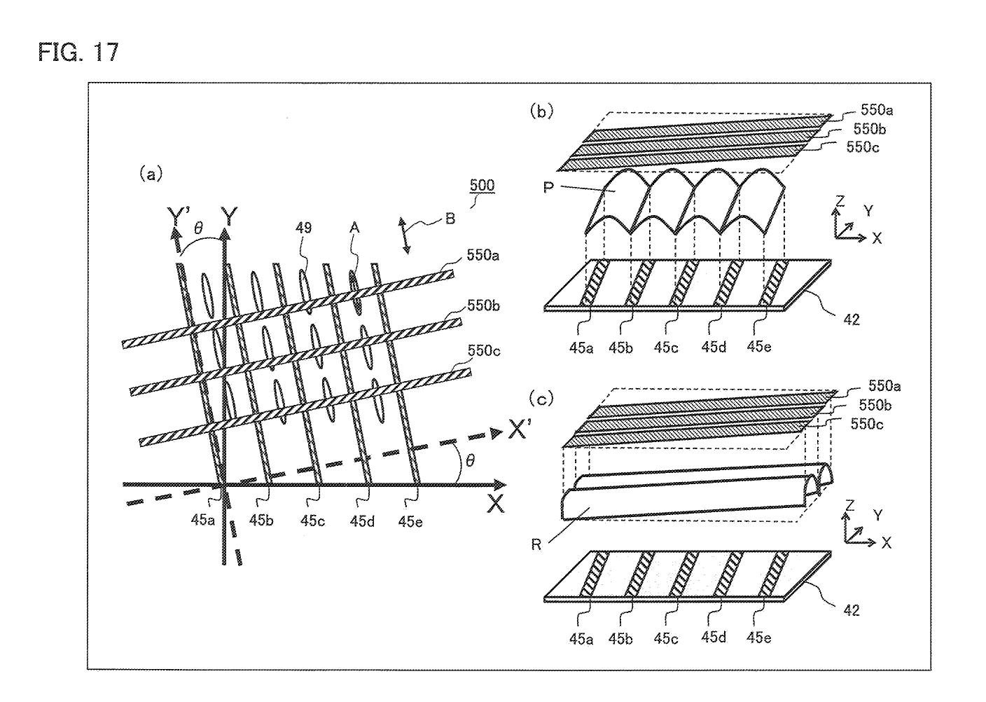

With reference to FIG. 17, the relationship between the arrangement of the electrodes 45a to 45e of the liquid crystal lens 500 and the orientation of the liquid crystal molecules 49 according to the modification will be described. FIG. 17(a) is a top view of the liquid crystal lens 500. FIG. 17(b) is an exploded perspective view of the liquid crystal lens 500, and shows virtual lenses P instead of the liquid crystal layer 43. FIG. 17(c) is an exploded perspective view of the liquid crystal lens 500, and shows virtual lenses R instead of the liquid crystal layer 43.

The direction of initial orientation of the liquid crystal molecules 49 (in FIG. 17(a), the direction of an arrow with a reference character A) is parallel to the Y′ axis. The direction of initial orientation of the liquid crystal molecules 49 may be substantially parallel to the extending direction of the electrodes 45a to 45e of the second electrode layer 45, and in FIG. 17(a), is parallel to the extending direction of the electrodes 45a to 45e. The direction of the transmission axis of the front-surface-side polarizing plate 66 (in FIG. 17(a), the direction of an arrow with a reference character B) is parallel to the Y′ axis. The direction of initial orientation of the liquid crystal molecules 49 is parallel to the transmission axis of the front-surface-side polarizing plate 66.

In the above configuration, by controlling a voltage applied between the first electrode layer 550 and the second electrode layer 45 of the liquid crystal lens 500, the same lens effect as that of the virtual lenses P (hereinafter referred to simply as lenses P) shown in FIG. 17(b) or the same lens effect as that of the virtual lenses R (hereinafter referred to simply as lenses R) shown in FIG. 17(c) can be realized. Since the lenses P (lenses for horizontal display) shown in FIG. 17(b) are identical to those shown in FIG. 11(b), description thereof is omitted.

As shown in FIG. 17(c), each lens R (lens for vertical display) is a cylindrical virtual lens which is convex in the Z axis positive direction with respect to the polarized light parallel to the Y′ axis, and the convex surface extends in the X′ axis direction. A plurality of lenses R are arranged in the Y′ axis direction. Light that has entered the lenses R from the second substrate 42 side is converged in the Y′ axis direction, and emitted to the first substrate 41 side.

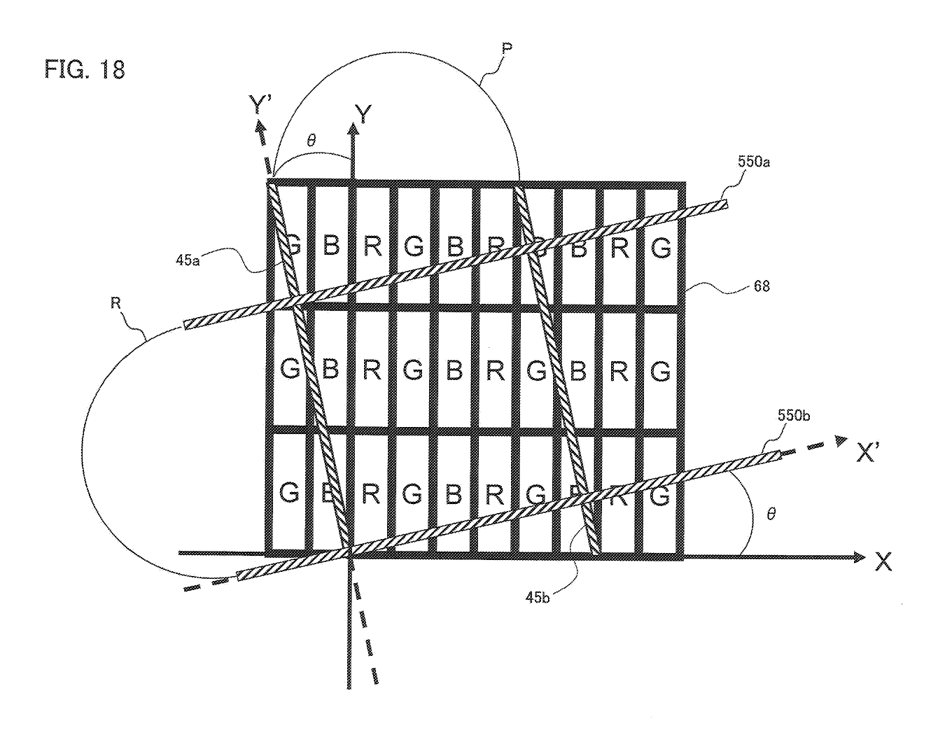

With reference to FIG. 18, the relationship between the arrangement of the electrodes 550a to 550c and 45a to 45e and the array of pixels, in the liquid crystal lens 500 according to the modification, is described. As shown in FIG. 18, the electrode 550a and the electrode 550b are disposed with a space corresponding to two sub pixels between them. The electrode 45a and the electrode 45b are disposed with a space corresponding to six sub pixels between them.

In this modification, the plurality of electrodes 550a to 550c of the first electrode layer 550 intersect at right angles with the plurality of electrodes 45a to 45e of the second electrode layer 45. Therefore, the refractive index distribution in the lenses P for horizontal display and the refractive index distribution in the lenses R for vertical display can be made more appropriate, thereby reducing crosstalk. Therefore, it is possible to realize an image display apparatus capable of performing switching between horizontal display and vertical display, and having high image visibility in naked eye 3D in both the horizontal display and the vertical display.

### Embodiment 3

Hereinafter, an image display apparatus according to Embodiment 3 will be described. In the above-described Embodiments 1 and 2 and modifications thereof, the direction of initial orientation of the liquid crystal molecules 49 is substantially parallel to the transmission axis of the front-surface-side polarizing plate 66. However, in this embodiment, the direction of initial orientation of the liquid crystal molecules 49 is not substantially parallel to the transmission axis of the front-surface-side polarizing plate 66 but is inclined by a predetermined angle θα (θα is an angle not smaller than 1° but smaller than 45°) with respect to the transmission axis. Hereinafter, differences from the modification of Embodiment 2 will be mainly described. The same functions and components as those of the modification of Embodiment 2 may be given the same reference numerals to omit repeated description thereof.

In the present embodiment, the image display apparatus includes a backlight 20, an image display panel 60 capable of displaying a 2D image or a 3D image, a liquid crystal lens 800, a display control section 65 for controlling the image display panel 60, and a control section 70 for controlling the liquid crystal lens 40. The liquid crystal lens 800 includes a first substrate 41, a second substrate 42, a liquid crystal layer 43, a first electrode layer 880, a second electrode layer 45, a first orientation film 46, and a second orientation film 47.

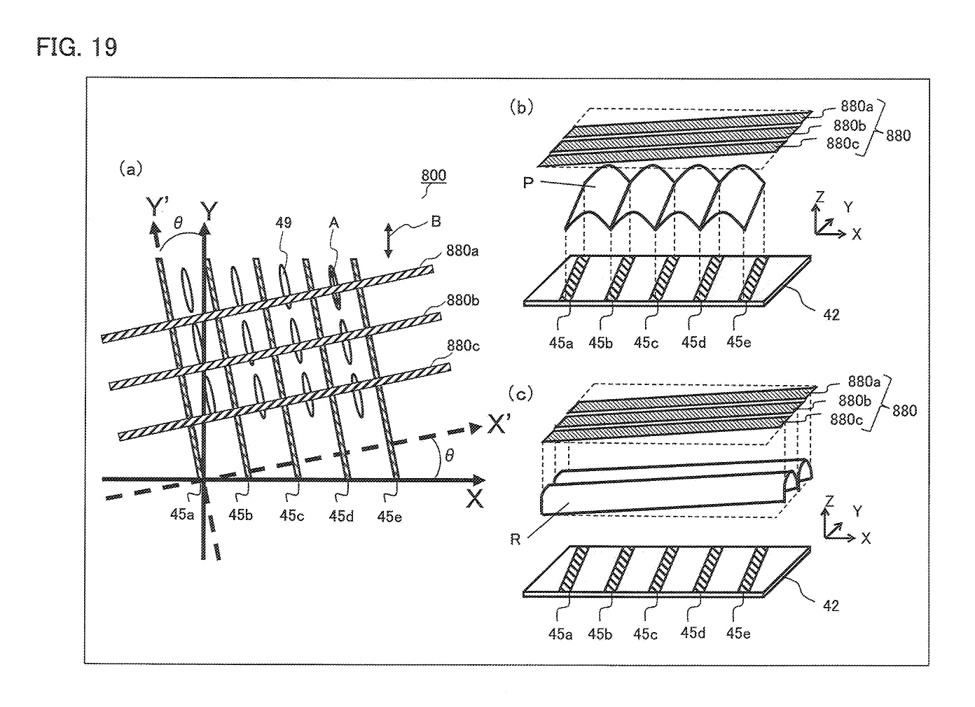

With reference to FIG. 19, the relationship between the arrangement of the electrodes 45a to 45e and the orientation of the liquid crystal molecules 49 in the liquid crystal lens 800 according to the present embodiment will be described. FIG. 19(a) is a top view of the liquid crystal lens 800. FIG. 19(b) is an exploded perspective view of the liquid crystal lens 800, showing virtual lenses P instead of the liquid crystal layer 43. FIG. 19(c) is an exploded perspective view of the liquid crystal lens 800, showing virtual lenses R instead of the liquid crystal layer 43.

In the present embodiment, the direction of initial orientation (in FIG. 19(a), the direction of an arrow with reference character A) of the liquid crystal molecules 49 is parallel to the Y′ axis. The direction of initial orientation of the liquid crystal molecules 49 may be substantially parallel to the extending direction of the electrodes 45a to 45e of the second electrode layer 45. The direction of the transmission axis (in FIG. 19(a), the direction of an arrow with reference character B) of the front-surface-side polarizing plate 66 is parallel to the Y axis. Thus, in the present embodiment, the direction of initial orientation of the liquid crystal molecules 49 is not substantially parallel to the transmission axis of the front-surface-side polarizing plate 66.

While in the present embodiment the electrodes of the first electrode layer 880 and the electrodes of the second electrode layer 45 are identical to those of the modification of the Embodiment 2, these electrodes may be identical to those of Embodiment 1. In this case, the image display apparatus of the present embodiment is identical to that shown in FIGS. 1 to 6 except the direction of the arrow B in FIG. 6. Alternatively, the electrodes of the present embodiment may be identical to those of Embodiment 2. In this case, the image display apparatus of the present embodiment is identical to that shown in FIGS. 10 to 12 except the direction of the arrow B in FIG. 11.

### EXAMPLES

Hereinafter, Examples 1 and 2 will be described. Example 1 corresponds to the configuration shown in FIG. 6, and the direction of initial orientation of the liquid crystal molecules 49 is parallel to the Y′ axis direction. Example 2 corresponds to the configuration shown in FIG. 7, and the direction of initial orientation of the liquid crystal molecules 49 is parallel to the Y direction.

### Example 1

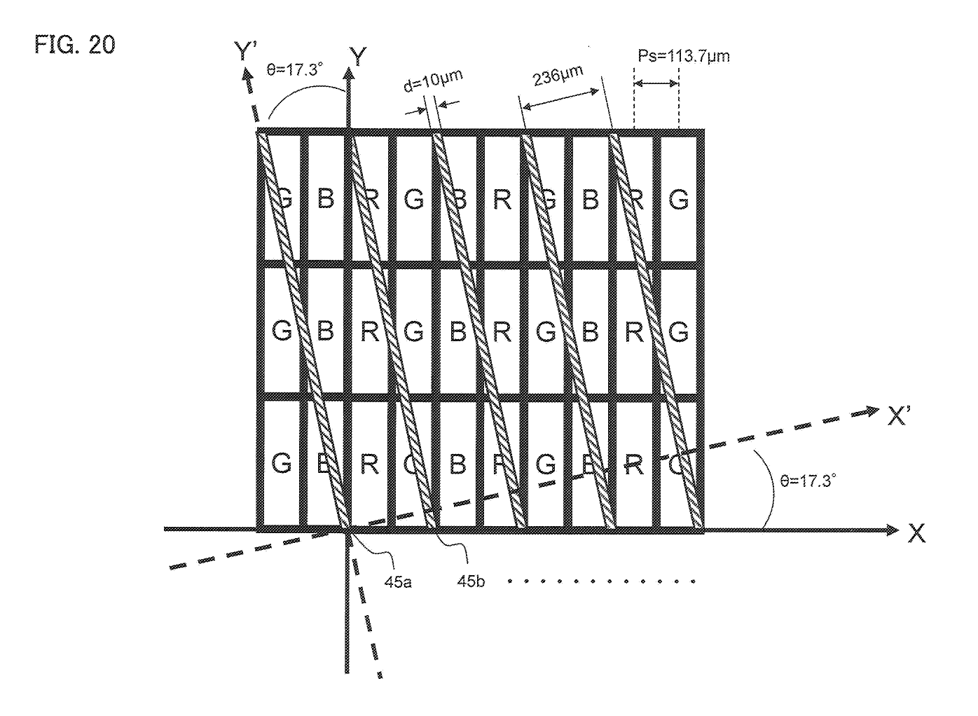

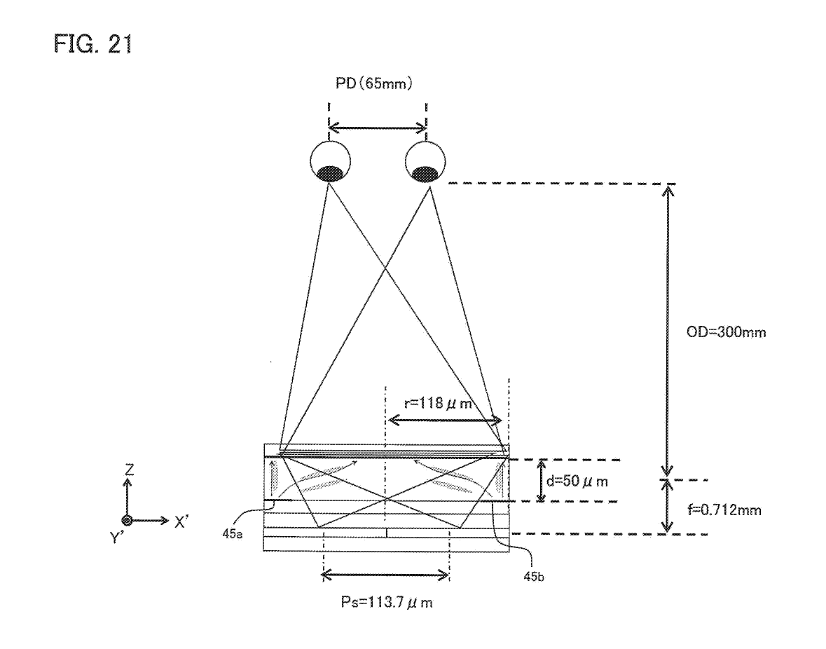

Parameter values of the image display panel according to Example 1 will be described with reference to FIG. 20 and FIG. 21.

As shown in FIG. 20, a plurality of sub pixels are arrayed in order of R, G, B in the X axis direction. The first electrode layer 44 is composed of a plane electrode. The second electrode layer 45 is composed of a plurality of electrodes 45a, 45b, . . . arrayed in a stripe pattern. The first electrode layer 44 and the second electrode layer 45 are made of ITO (Indium Tin Oxide). The electrodes 45a, 45b, . . . extend in the Y′ axis direction, and are periodically arranged in the X′ axis direction. The Y′ axis is inclined by 17.3° with respect to the Y axis. The width of each of the electrodes 45a, 45b, . . . in the X′ axis direction is 10 μm, and the pitch of the electrodes 45a, 45b, . . . in the X′ axis direction is 236 μm. The pitch of the lenses P of the liquid crystal lens 40 in the X′ direction is the same as the pitch of the electrodes 45a, 45b, . . . in the X′ axis direction, and it is 236 μm.

As shown in FIG. 21, a pitch Ps of the sub pixels of the image display panel 60 is 113.7 μm, a viewing distance OD of the viewer is 300 mm, a distance PD between the eyes of the viewer is 65 mm, a distance f between the liquid crystal lens 40 and the pixels is 0.712 mm, and a thickness (cell gap) d of the liquid crystal layer 43 is 50 μm.

Further, an elastic coefficient K11 relating to spreading deformation of the liquid crystal layer 43 is 12, an elastic coefficient K22 relating to torsional deformation is 7, and an elastic coefficient K33 relating to bending deformation is 20. A dielectric constant ∈1 of the liquid crystal layer 43 in the director direction is 9, and a dielectric constant ∈2 in a direction perpendicular to the director direction is 4. The rotational viscosity of the liquid crystal is 182. The direction of initial orientation of the liquid crystal molecules 49 is parallel to the Y′ axis. A voltage applied to the second electrode layer 45 (electrodes 45a, 45b, . . . ) is 7 V, and a voltage applied to the first electrode layer 44 is 0 V.

Liquid crystal orientation simulation based on the finite element method is performed by using the parameters described above.

In the simulation, the director at each position in the liquid crystal layer 43 is obtained. Based on this information, the refractive index sensed by light at each position in the liquid crystal layer 43 is calculated using the following equation (1). The polarization direction of light that enters the liquid crystal lens 40 is parallel to the Y′ axis.

$$n ( α ) = \frac{ {n}_{e} \cdot {n}_{o}}{\sqrt{{n}_{e}^{2} \cdot {sin}^{2} α + {n}_{o}^{2} \cdot {cos}^{2} α }} \qquad ( 1 )$$

In equation (1), ne is a refractive index of the liquid crystal to extraordinary light, no is a refractive index of the liquid crystal to ordinary light, α is an angle at which liquid crystal rises when a voltage is applied, namely, an angle formed between the XY plane or the X′Y′ plane and the director.

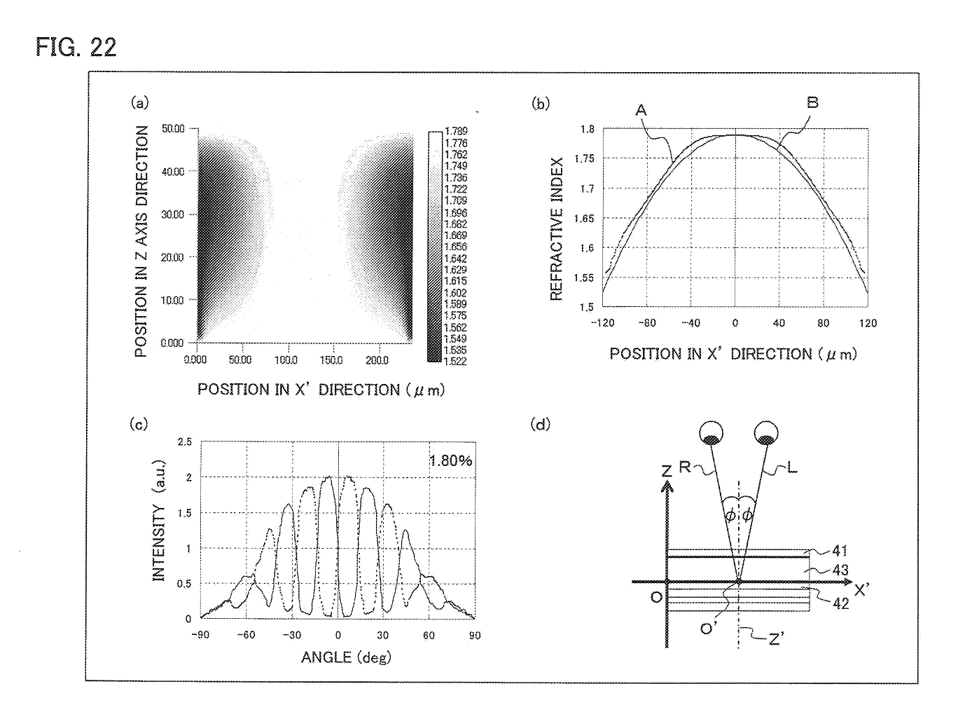

In this example, the refractive index ne of the liquid crystal layer 43 to extraordinary light is set at 1.789, and the refractive index no to ordinary light is set at 1.522. That is, Δn is 0.267. FIG. 22 shows optical characteristics of the example.

FIG. 22(a) is a schematic view showing, by shading of color, a change in the refractive index in the liquid crystal lens 40 of Example 1. In FIG. 22(a), the vertical axis represents the thickness of the liquid crystal lens 40 in the Z axis direction, namely, the positions in the range of the cell gap d, and the horizontal axis represents the positions in the X′ axis direction.

Definition of the vertical axis (Z axis) and the horizontal axis (X′ axis) in FIG. 22(a) is described with reference to FIG. 22(d). FIG. 22(d) is a diagram obtained by applying the vertical axis and the horizontal axis of FIG. 22(a) to the schematic view of FIG. 8 showing the liquid crystal lens 40. As shown in FIG. 22(d), the horizontal axis (X′ axis) corresponds to the position of the interface between the liquid crystal layer 43 and the second substrate 42. The vertical axis (Z axis) corresponds to the position of the left end of the liquid crystal lens 40. The intersection of the vertical axis (Z axis) and the horizontal axis (X′ axis) is an origin O.

In FIG. 22(a), a light-colored portion (white portion) represents an area where the refractive index is relatively high, and a dark-colored portion (black portion) represents an area where the refractive index is relatively low.

FIG. 22(b) shows a graph obtained by averaging the refractive indices in the Z axis direction at the respective positions in the horizontal axis (X′ axis) in the refractive index distribution shown in FIG. 22(a).

In FIG. 22(b), the horizontal axis represents the positions in the liquid crystal lens 40 along the X′ axis direction, like the horizontal axis in FIG. 22(a), and the vertical axis represents the refractive index.

FIG. 22(b) shows a graph A representing the refractive index distribution of Example 1, and a graph B representing refractive index distribution of an ideal GRIN lens (refractive index distribution lens). As shown in the graph B, the refractive index distribution of the ideal GRIN lens is shown by a quadratic curve. The shape of the graph A representing the refractive index distribution of Example 1 is similar to the shape of the graph B representing the refractive index distribution of the ideal GRIN lens.

FIG. 22(c) is a graph showing the result of calculating light distribution characteristics after light has passed through the liquid crystal lens 40, by using the refractive index distribution shown in FIG. 22(a). In FIG. 22(c), a graph shown by a solid line represents light for the right eye of the viewer, and a graph shown by a dashed line represents light for the left eye of the viewer. In FIG. 22(c), the vertical axis represents the intensity of light, and the horizontal axis represents the angle φ of light emitted from the liquid crystal lens 40. Definition of the angle φ is described with reference to FIG. 22(d). As shown in FIG. 22(d), a point of intersection between the X′ axis and a line segment Z′ that passes the center of the liquid crystal lens 40 and extends in the Z axis direction is an origin O′. A line segment connecting the origin O′ with the right eye of the viewer is a line segment R, and a line segment connecting the origin O′ with the left eye of the viewer is a line segment L. Either an angle formed between the line segment Z′ and the line segment R or an angle formed between the line segment Z′ and the line segment L, which is more acute than the other, is defined as the angle φ. When the line segment Z′ is used as a reference, the viewer's right eye side is defined as a negative direction, and the viewer's left eye side is defined as a positive direction.

A light beam tracking simulation is performed with the light distribution characteristics of the light source being Lambertian, the wavelength of light emitted from the light source being 550 nm, and the light source being located at the position of the right-eye pixels. Next, the position of the light source is shifted to the position of the left-eye pixels, and a light beam tracking simulation is performed again.

Since the viewing distance OD of the viewer is 300 mm and the distance PD between the eyes of the viewer is 65 mm, the angle φ formed between the line segment Z′ and the line segment R (line segment corresponding to the right eye) is −6.2°. That is, the right eye of the viewer is located at the position where the angle φ is −6.2°. Likewise, the left eye of the viewer is located at the position where the angle φ is +6.2°. As shown in FIG. 22(c), the intensity of the light for the right eye is 2 when the angle φ is −6.2°. The intensity of the light for the left eye is 2 when the angle φ is +6.2°. That is, even in the configuration in which the electrodes are inclined in the Y′ axis direction like in Example 1, the light from the right-eye pixel appropriately enters the right eye of the viewer, and the light from the left-eye pixel appropriately enters the left eye of the viewer.

### Example 2

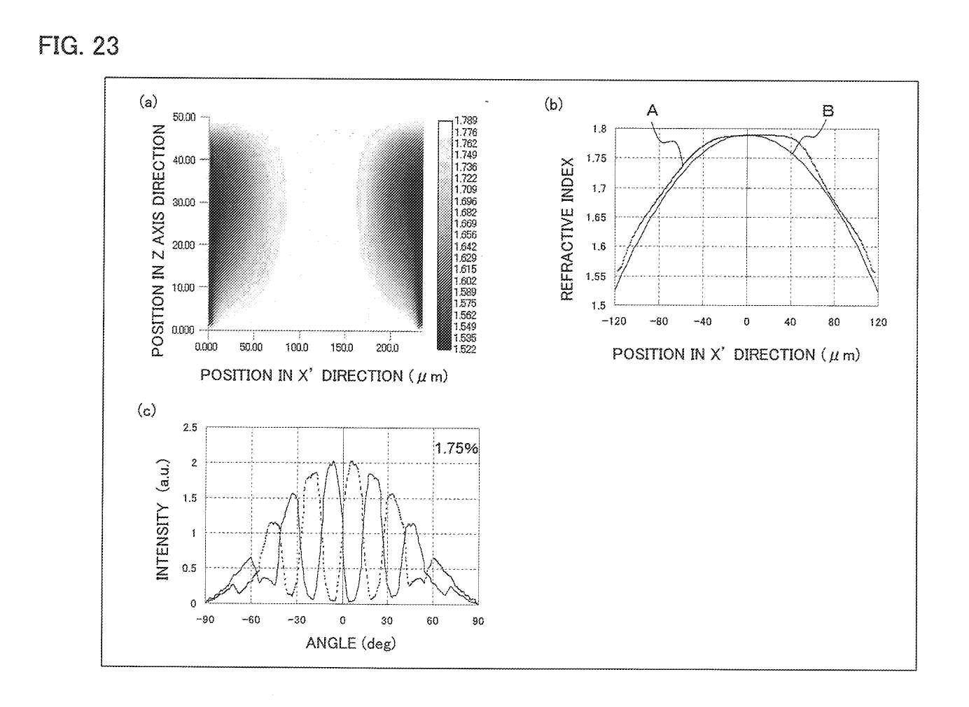

Example 2 is different from Example 1 in that the direction of initial orientation of the liquid crystal molecules 49 and the polarization direction of light incident on the liquid crystal lens 40 are parallel to the Y axis. Other parameters are identical to those of Example 1. FIG. 23 shows a simulation result of Example 2.

FIG. 23(a) shows refractive index distribution of the liquid crystal lens 40 of Example 2. As shown in FIG. 23(a), the liquid crystal lens 40 of Example 2 also has the refractive index distribution. FIG. 23(b) is a graph showing the refractive index distribution of Example 2. As shown in FIG. 23(b), the shape of the refractive index distribution of Example 2 is similar to the shape of ideal refractive index distribution. FIG. 23(c) shows light distribution characteristics of Example 2. As shown in FIG. 23(c), the liquid crystal lens of Example 2 allows light from the right-eye pixel and light from the left-eye pixel to appropriately enter the right and left eyes of the viewer.

The present disclosure is applicable to an image display apparatus capable of 3D display, and the like. For example, the present disclosure is applicable to a television, a monitor, a tablet PC, a digital still camera, a movie, a camera-equipped cellular phone, a smartphone, and the like.

As presented above, the embodiments have been described as examples of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

What is claimed is:

1. An image display apparatus comprising:
a display panel; and
a liquid crystal lens disposed in front of the display panel, wherein
the display panel comprises:
a black matrix forming a plurality of pixels and including black lines extending in a predetermined direction; and
a front-surface-side polarizing plate located on a front surface side of the display panel, and
the liquid crystal lens comprises:
a first substrate and a second substrate arranged so as to oppose each other;
a first electrode layer formed on the first substrate;
a second electrode layer having a plurality of electrodes formed in a stripe pattern on the second substrate; and
a liquid crystal layer disposed between the first electrode layer and the second electrode layer, and having a plurality of liquid crystal molecules, in which a direction of orientation of the liquid crystal molecules is changed in accordance with a voltage applied between the first electrode layer and the second electrode layer, thereby to generate a lens effect, and
in the second electrode layer, the plurality of electrodes extend in a direction inclined with respect to the black lines of the black matrix, and
a direction of initial orientation of the liquid crystal molecules is substantially parallel to a transmission axis of the front-surface-side polarizing plate.

2. The image display apparatus according to claim 1, wherein
the first electrode layer is composed of a single electrode opposing the plurality of electrodes of the second electrode layer.

3. The image display apparatus according to claim 1, wherein
the first electrode layer includes a plurality of electrodes that are formed in a stripe pattern on the first substrate, and overlap the plurality of electrodes of the second electrode layer.

4. The image display apparatus according to claim 3, wherein
the plurality of electrodes of the first electrode layer overlap at right angles with the plurality of electrodes of the second electrode layer.

5. The image display apparatus according to claim 1, wherein
the direction of initial orientation of the liquid crystal molecules is substantially parallel to, among the black lines of the black matrix, a black line having a smaller acute angle with the electrodes of the second electrode layer than another of the black lines that forms a larger acute angle with the electrodes of the second layer.

6. A liquid crystal lens for use with and disposed in front of a display panel in an image display apparatus, the display panel having a black matrix including black lines extending in a predetermined direction, the liquid crystal lens comprising:
a first substrate and a second substrate arranged so as to oppose each other;
a first electrode layer formed on the first substrate;
a second electrode layer having a plurality of electrodes formed in a stripe pattern on the second substrate; and
a liquid crystal layer disposed between the first electrode layer and the second electrode layer, and having a plurality of liquid crystal molecules, in which a direction of orientation of the liquid crystal molecules is changed in accordance with a voltage applied between the first electrode layer and the second electrode layer, thereby to generate a lens effect, wherein:
the second electrode layer is to be positioned with respect to the display panel such that the plurality of electrodes extend in a direction inclined with respect to the black lines of the black matrix of the display panel, and
a direction of initial orientation of the liquid crystal molecules is substantially parallel to a transmission axis of a front-surface-side polarizing plate disposed in front of the display panel.
